(19) United States
(12) Patent Application Publication
(10) Pub. No.: US 2025/0203698 A1
(43) Pub. Date: Jun. 19, 2025

(54) METHOD FOR TRANSMITTING AND RECEIVING SIGNALS IN WIRELESS COMMUNICATION SYSTEM, AND DEVICE SUPPORTING SAME

(71) Applicant: LG ELECTRONICS INC., Seoul (KR)

(72) Inventors: Jeongsu LEE, Seoul (KR); Youngdae LEE, Seoul (KR); Seunggye HWANG, Seoul (KR); Hyunsoo KO, Seoul (KR); Jaenam SHIM, Seoul (KR)

(73) Assignee: LG ELECTRONICS INC., Seoul (KR)

(21) Appl. No.: 18/846,177

(22) PCT Filed: Nov. 25, 2022
(86) PCT No.: PCT/KR2022/018816

§ 371 Date: Sep. 11, 2024

(30) Foreign Application Priority Data
Apr. 29, 2022 (KR) 10-2022-0053222

(51) Int. Cl. H04W 76/27; H04W 52/36; H04W 74/0833

(52) U.S. Cl. CPC H04W 76/27; H04W 52/367; H04W 74/0833

(57) ABSTRACT

An embodiment relates to a next-generation wireless communication system for supporting a higher data transmission rate, etc. than that of a 4^{th} generation (4G) wireless communication system. According to an embodiment, a method for transmitting and receiving signals in a wireless communication system and a device supporting same may be provided, and another embodiment may be provided.

### TECHNICAL FIELD

An embodiment relates to a wireless communication system.

### BACKGROUND ART

As a number of communication devices have required higher communication capacity, the necessity of the mobile broadband communication much improved than the existing radio access technology (RAT) has increased. In addition, massive machine type communications (MTC) capable of providing various services at anytime and anywhere by connecting a number of devices or things to each other has been considered in the next generation communication system. Moreover, a communication system design capable of supporting services/UEs sensitive to reliability and latency has been discussed.

### DISCLOSURE

### Technical Tasks

The embodiment may provide a method and apparatus for transmitting and receiving a signal in a wireless communication system.

It will be appreciated by persons skilled in the art that the objects that could be achieved with the embodiment is not limited to what has been particularly described hereinabove and the above and other objects that the embodiment could achieve will be more clearly understood from the following detailed description.

### Technical Solutions

In an embodiment, provided herein are a method of transmitting and receiving signals in a wireless communication system and apparatus supporting the same.

According to the embodiment, a method performed by a User Equipment (UE) in a wireless communication system may be provided.

According to one embodiment, the method may include receiving a Radio Resource Control (RRC) signal including configuration information of a Sounding Reference Signal (SRS).

According to one embodiment, the configuration information may include one or more parameters for determining transmission power of the SRS.

According to one embodiment, the method may include transmitting the SRS based on the configuration information.

According to one embodiment, the RRC signal may be received in an RRC connected state.

According to one embodiment, based on (i) transmitting the SRS in an RRC inactive state and (ii) transmitting an Uplink (UL) signal different from the SRS by the UE in the RRC inactive state before transmitting the SRS, the transmission power may be determined based on the one or more parameters and one or more power offsets for compensation of the one or more parameters.

According to one embodiment, the one or more power offsets may be determined based on the UL signal.

According to one embodiment, in the RRC connected state, a window may be configured in a time domain.

According to one embodiment, based on (i) transmitting the SRS in the RRC inactive state, (ii) transmitting the UL signal by the UE in the RRC inactive state before transmitting the SRS, (iii) a transmission start time of the SRS being included in the window, the transmission power may be determined based on the one or more parameters and the one or more power offsets.

According to one embodiment, based on (i) transmitting the SRS in the RRC inactive state and (ii) the transmission start time of the SRS not being included in the window, the transmission power may be determined based on the one or more parameters.

According to one embodiment, based on that a value obtained based on compensating the one or more power offsets in the one or more parameters exceeds a preset threshold, the transmission power may be determined as a value related to the preset threshold.

According to one embodiment, the preset threshold may be a power limitation configured in the RRC connected state or a maximum transmission power of the UE.

According to one embodiment, a weight parameter applied to the one or more power offsets may be configured.

According to one embodiment, the weight parameter may have a real number equal to or greater than 0 and equal to or smaller than 1.

According to one embodiment, the one or more parameters may be compensated with a value obtained based on applying the weight parameter to the one or more power offsets.

According to one embodiment, based on the UL signal being a Physical Random Access Channel (PRACH), the one or more power offsets may be determined as a total power ramp-up related to transmission of the PRACH.

According to one embodiment, based on the UL signal being a response signal to a Random Access Response (RAR), the one or more power offsets may be determined as a Transmit Power Control (TPC) command value included in the RAR.

According to one embodiment, based on the UL signal being a Physical Uplink Shared Channel (PUSCH), the one or more power offsets may be determined as Δ_{TF,b,F,c}(t−1)+f_{b,f,c}(t−1), l−1).

According to one embodiment, Δ_{TF,b,r,c}(t−1) may be a delta function used transmission power determination of the PUSCH transmitted in a PUSCH transmission occasion i−1.

According to one embodiment, f_{b,f,c}(t−1), l−1) may be a value related to a PUSCH power control coordination state used for the transmission power determination of the PUSCH transmitted in the PUSCH transmission occasion i−1.

According to one embodiment, based on the UL BPS signal being a Physical Uplink Control Channel (PUCCH), the one or more power offsets may be determined as Δ_{F_RUCCH}(F)+Δ_{TF,g,F,c}(i−1)+g_{b,f,c}(i−1), l−1).

According to one embodiment, Δ_{F_RUCCH}(F) may be a first delta function used for transmission power determination of the PUCCH.

According to one embodiment, Δ_{TF,g,F,c}(i−1) may be a second delta function used for the transmission power determination of the PUCCH transmitted in a PUCCH transmission occasion i−1.

According to one embodiment, g_{b,f,c}(i−1), l−1) may be a value related to a PUCCH power control coordination state used for the transmission power determination of the PUCCH transmitted in the PUCCH transmission occasion i−1.

According to one embodiment, a User Equipment (UE) operating in a wireless communication system may be provided.

According to one embodiment, the UE may include a transceiver and one or more processors connected to the transceiver.

According to one embodiment, the one or more processors may be configured to receive a Radio Resource Control (RRC) signal including configuration information of a Sounding Reference Signal (SRS).

According to one embodiment, the configuration information may include one or more parameters for determining transmission power of the SRS.

According to one embodiment, the one or more processors may be configured to transmit the SRS based on the configuration information.

According to one embodiment, the RRC signal may be received in an RRC connected state.

According to one embodiment, based on transmitting the SRS in an RRC inactive state and (ii) transmitting an Uplink (UL) signal different from the SRS by the UE in the RRC inactive state before transmitting the SRS, the transmission power may be determined based on the one or more parameters and one or more power offsets for compensation of the one or more parameters.

According to one embodiment, the one or more power offsets may be determined based on the UL signal.

According to one embodiment, in the RRC connected state, a window may be configured in a time domain.

According to one embodiment, based on (i) transmitting the SRS in the RRC inactive state, (ii) transmitting the UL signal by the UE in the RRC inactive state before transmitting the SRS, and (iii) a transmission start time of the SRS being included in the window, the transmission power may be determined based on the one or more parameters and the one or more power offsets.

According to one embodiment, based on (i) transmitting the SRS in the RRC inactive state and (ii) the transmission start time of the SRS not being included in the window, the transmission power may be determined based on the one or more parameters.

According to one embodiment, the one or more processors may be configured to communicate with one or more of a mobile terminal, a network, and an autonomous vehicle other than a vehicle including the UE.

According to one embodiment, a method performed by a base station in a wireless communication system may be provided.

According to one embodiment, the method may include transmitting a Radio Resource Control (RRC) signal including configuration information of a Sounding Reference Signal (SRS).

According to one embodiment, the configuration information may include one or more parameters for determining transmission power of the SRS.

According to one embodiment, the method may include receiving the SRS related to the configuration information from a user equipment.

According to one embodiment, the RRC signal may be transmitted in an RRC connected state.

According to one embodiment, based on (i) receiving the SRS in an RRC inactive state of an RRC state of the user equipment and (ii) receiving an Uplink (UL) signal different from the SRS from the user equipment in the RRC inactive state before receiving the SRS, the transmission power may be determined based on the one or more parameters and one or more power offsets for compensation of the one or more parameters.

According to one embodiment, the one or more power offsets may be determined based on the UL signal.

According to one embodiment, a base station operating in a wireless communication system may be provided.

According to one embodiment, the base station may include a transceiver and one or more processors connected to the transceiver.

According to one embodiment, the one or more processors may be configured to transmit a Radio Resource Control (RRC) signal including configuration information of a Sounding Reference Signal (SRS).

According to one embodiment, the configuration information may include one or more parameters for determining transmission power of the SRS.

According to one embodiment, the one or more processors may bee configured to receive, from a user equipment, the SRS related to the configuration information.

According to one embodiment, the RRC signal may be transmitted in an RRC connected state.

According to one embodiment, based on (i) receiving the SRS in an RRC inactive state of an RRC state of the user equipment and (ii) receiving an Uplink (UL) signal different from the SRS from the user equipment in the RRC inactive state before receiving the SRS, the transmission power may be determined based on the one or more parameters and one or more power offsets for compensation of the one or more parameters.

According to one embodiment, the one or more power offsets may be determined based on the UL signal.

According to one embodiment, an apparatus operating in a wireless communication system may be provided.

According to one embodiment, the apparatus may include one or more processors and one or more memories operably coupled to the one or more processors and storing one or more instructions for enabling the one or more processors to perform operations based on being executed.

According to one embodiment, the operations may include receiving a Radio Resource Control (RRC) signal including configuration information of a Sounding Reference Signal (SRS).

According to one embodiment, the configuration information may include one or more parameters for determining transmission power of the SRS.

According to one embodiment, the operations may include transmitting the SRS based on the configuration information.

According to one embodiment, the RRC signal may be received in an RRC connected state.

According to one embodiment, based on (i) transmitting the SRS in an RRC inactive state and (ii) transmitting an Uplink (UL) signal different from the SRS by the apparatus in the RRC inactive state before transmitting the SRS, the transmission power is determined based on the one or more parameters and one or more power offsets for compensation of the one or more parameters.

According to one embodiment, the one or more power offsets may be determined based on the UL signal.

According to one embodiment, a non-transitory processor-readable medium storing one or more instructions for enabling one or more processors to perform operations may be provided.

According to one embodiment, the operations may include receiving a Radio Resource Control (RRC) signal including configuration information of a Sounding Reference Signal (SRS).

According to one embodiment, the configuration information may include one or more parameters for determining transmission power of the SRS.

According to one embodiment, the operations may include transmitting the SRS based on the configuration information.

According to one embodiment, the RRC signal may be received in an RRC connected state.

According to one embodiment, based on (i) transmitting the SRS in an RRC inactive state and (ii) transmitting an Uplink (UL) signal different from the SRS by a device including the one or more processors in the RRC inactive state before transmitting the SRS, the transmission power may be determined based on the one or more parameters and one or more power offsets for compensation of the one or more parameters.

According to one embodiment, the one or more power offsets may be determined based on the UL signal.

It will be appreciated by persons skilled in the art that the effects that can be achieved with the embodiment is not limited to what has been particularly described hereinabove and other advantages of the embodiment will be more clearly understood from the following detailed description taken in conjunction with the accompanying drawings.

### Advantageous Effects

According to the embodiment, a signal may be effectively transmitted and received in a wireless communication system.

According to the embodiment, positioning may be effectively performed in a wireless communication system.

It will be appreciated by persons skilled in the art that the effects that can be achieved with the embodiment is not limited to what has been particularly described hereinabove and other advantages of the embodiment will be more clearly understood from the following detailed description taken in conjunction with the accompanying drawings.

### DESCRIPTION OF DRAWINGS

The accompanying drawings are provided to help understanding of the embodiment, along with a detailed description. However, the technical features of the embodiment is not limited to a specific drawing, and features disclosed in each drawing may be combined with each other to constitute a new embodiment. Reference numerals in each drawing denote structural elements.

FIG. 1 is a diagram illustrating physical channels and a signal transmission method using the physical channels, which may be used in the embodiment.

FIG. 2 is a diagram illustrating examples of an RRC state, an RRC state transition, and a mobility procedure supported between an NR/NGC (Next Gen Core) and an E-UTRAN/EPC (Evolved-Universal Terrestrial Radio Access Network/Evolved Packet Core), to which one embodiment is applicable . . .

FIG. 3 is a diagram illustrating an example of an uplink transmission power control procedure to which one embodiment is applicable.

FIG. 4 is a diagram illustrating an exemplary positioning protocol configuration for user equipment (UE) positioning, which is applicable to the embodiment.

FIG. 5 is a diagram illustrating an observed time difference of arrival (OTDOA) positioning method, to which the embodiment is applicable.

FIG. 6 is a diagram illustrating a multi-round trip time (multi-RTT) positioning method to which the embodiment is applicable.

FIG. 7 is a simplified diagram illustrating a method of operating a UE, a transmission and reception point (TRP), a location server, and/or a location management function (LMF) according to the embodiment.

FIG. 8 is a simplified diagram illustrating a method of operating a UE, a transmission and reception point (TRP), a location server, and/or a location management function (LMF) according to the embodiment.

FIG. 9 is a diagram schematically illustrating an operation method of a UE and a network node according to the embodiment.

FIG. 10 is a flowchart illustrating an operating method of a UE according to the embodiment.

FIG. 11 is a flowchart illustrating an operating method of a network node according to the embodiment.

FIG. 12 is a block diagram illustrating an apparatus for implementing the embodiment.

FIG. 13 is a diagram illustrating a communication system to which the embodiment is applicable.

FIG. 14 is a block diagram illustrating wireless devices to which the embodiment is applicable.

FIG. 15 is a block diagram illustrating another example of wireless devices to which the embodiment is applicable.

FIG. 16 is a block diagram illustrating a portable device applied to the embodiment.

FIG. 17 is a block diagram illustrating a vehicle or an autonomous driving vehicle, which is applied to the embodiment.

### BEST MODE

The embodiment is applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

The embodiment is described in the context of a 3GPP communication system (e.g., including LTE, NR, 6G, and next-generation wireless communication systems) for clarity of description, to which the technical spirit of the embodiment is not limited. For the background art, terms, and abbreviations used in the description of the embodiment, refer to the technical specifications published before the present disclosure. For example, the documents of 3GPP TS 36.211, 3GPP TS 36.212, 3GPP TS 36.213, 3GPP TS 36.300, 3GPP TS 36.321, 3GPP TS 36.331, 3GPP TS 36.355, 3GPP TS 36.455, 3GPP TS 37.355, 3GPP TS 37.455, 3GPP TS 38.211, 3GPP TS 38.212, 3GPP TS 38.213, 3GPP TS 38.214, 3GPP TS 38.215, 3GPP TS 38.300, 3GPP TS 38.321, 3GPP TS 38.331, 3GPP TS 38.355, 3GPP TS 38.455, and so on may be referred to.

### 1. 3GPP System

### 1.1. Physical Channels and Signal Transmission and Reception

In a wireless access system, a UE receives information from a base station on a downlink (DL) and transmits information to the base station on an uplink (UL). The information transmitted and received between the UE and the base station includes general data information and various types of control information. There are many physical channels according to the types/usages of information transmitted and received between the base station and the UE.

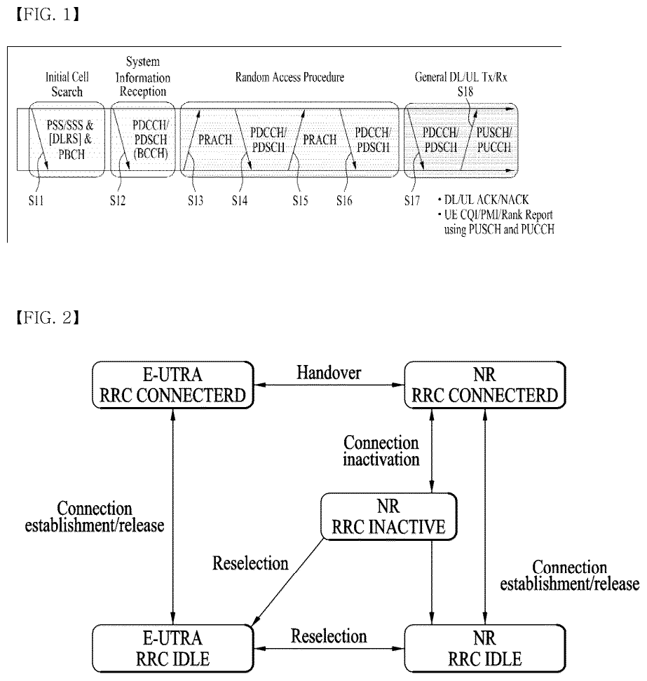

FIG. 1 is a diagram illustrating physical channels and a signal transmission method using the physical channels, which may be used in the embodiment.

When powered on or when a UE initially enters a cell, the UE performs initial cell search involving synchronization with a BS in step S11. For initial cell search, the UE receives a synchronization signal block (SSB). The SSB includes a primary synchronization signal (PSS), a secondary synchronization signal (SSS), and a physical broadcast channel (PBCH). The UE synchronizes with the BS and acquires information such as a cell Identifier (ID) based on the PSS/SSS. Then the UE may receive broadcast information from the cell on the PBCH. In the meantime, the UE may check a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in step S12.

Subsequently, to complete connection to the eNB, the UE may perform a random access procedure with the eNB (S13 to S16). In the random access procedure, the UE may transmit a preamble on a physical random access channel (PRACH) (S13) and may receive a PDCCH and a random access response (RAR) for the preamble on a PDSCH associated with the PDCCH (S14). The UE may transmit a physical uplink shared channel (PUSCH) by using scheduling information in the RAR (S15), and perform a contention resolution procedure including reception of a PDCCH signal and a PDSCH signal corresponding to the PDCCH signal (S16).

Aside from the above 4-step random access procedure (4-step RACH procedure or type-1 random access procedure), when the random access procedure is performed in two steps (2-step RACH procedure or type-2 random access procedure), steps S13 and S15 may be performed as one UE transmission operation (e.g., an operation of transmitting message A (MsgA) including a PRACH preamble and/or a PUSCH), and steps S14 and S16 may be performed as one BS transmission operation (e.g., an operation of transmitting message B (MsgB) including an RAR and/or contention resolution information)

After the above procedure, the UE may receive a PDCCH and/or a PDSCH from the BS (S17) and transmit a PUSCH and/or a physical uplink control channel (PUCCH) to the BS (S18), in a general UL/DL signal transmission procedure.

Control information that the UE transmits to the BS is generically called uplink control information (UCI). The UCI includes a hybrid automatic repeat and request acknowledgement/negative acknowledgement (HARQ-ACK/NACK), a scheduling request (SR), a channel quality indicator (CQI), a precoding matrix index (PMI), a rank indicator (RI), etc.

In general, UCI is transmitted periodically on a PUCCH. However, if control information and traffic data should be transmitted simultaneously, the control information and traffic data may be transmitted on a PUSCH. In addition, the UCI may be transmitted aperiodically on the PUSCH, upon receipt of a request/command from a network.

### RRC (Radio Resource Control) State

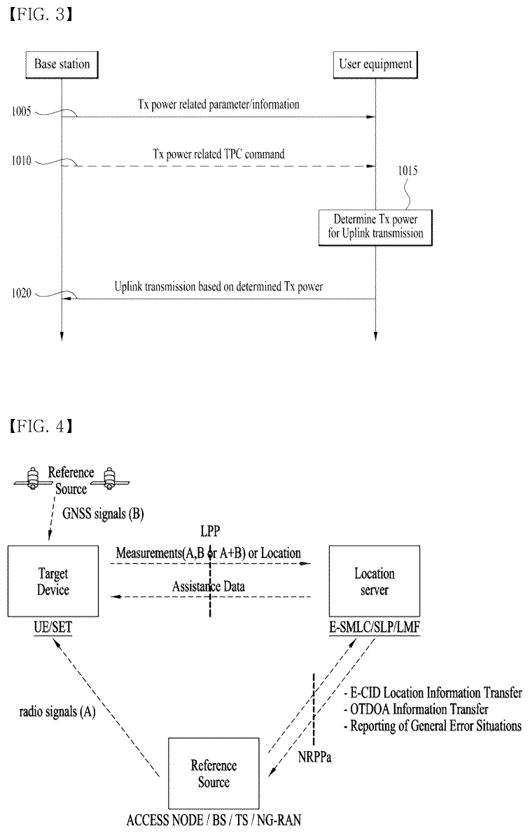

FIG. 2 is a diagram illustrating examples of an RRC state, an RRC state transition, and a mobility procedure supported between an NR/NGC (Next Gen Core) and an E-UTRAN/EPC (Evolved-Universal Terrestrial Radio Access Network/Evolved Packet Core), to which one embodiment is applicable.

The UE has only one RRC state at a specific time. The RRC state may indicate whether the RRC layer of the UE was logically connected to an NG RAN (Radio Access Network) layer. When the RRC connection is established, the UE is in an RRC_CONNECTED or RRC_INACTIVE state. Alternatively, when the RRC connection is not established, the UE is in the RRC_idle state.

When the UE is in RRC_CONNECTED or RRC_INACTIVE state, the UE has RRC connection, so that the NG RAN may recognize the presence of the UE for each cell. On the other hand, when the UE is in RRC_IDLE state, the UE cannot be recognized by the NG RAN, and the UE is managed by a core network for each tracking area unit that is larger in size than the cell.

When an initial user powers on the UE, the UE may search for an appropriate cell, and may maintain the RRC_IDLE state in the corresponding cell. If only the RRC connection needs to be established, the UE in the RRC_IDLE state may establish RRC connection with the NG RAN through the RRC connection procedure, and may transition to the RRC_CONNECTED or RRC_INACTIVE state.

RRC states of the UE may have the following characteristics.

(1) RRC_IDLE state
Discontinuous reception (DRX) is established in the UE by higher layer signaling.
UE mobility is controlled based on network configuration.
UE monitors a paging channel.
UE performs neighbor cell measurement and cell (re) selection.
UE obtains system information.

(2) RRC_INACTIVE state
Discontinuous reception (DRX) is established in the UE by higher layer signaling or by RRC layer signaling.
UE mobility is controlled based on network configuration.
UE stores an Access Stratum (AS) context
UE monitors a paging channel.
UE performs neighbor cell measurement and cell (re) selection.
When the UE moves out of a RAN-based notification area, the UE updates the RAN-based notification area.
UE obtains system information.

(3) RRC_CONNECTED state
UE stores the AS context.
UE transmits and receives unicast data.
In a lower layer, a UE-specific DRX may be configured in the UE.
For increased bandwidth, a UE supporting carrier aggregation (CA) may use at least one SCell combined with a specific cell (SpCell).
For increased bandwidth, a UE supporting dual connectivity (DC) may use a secondary cell group (SCG) combined with a master cell group (MCG).
UE monitors a paging channel.
When data is scheduled for the UE, the UE monitors control channels related to a shared data channel.
UE provides channel quality and feedback information.
UE performs neighbor cell measurement and cell (re) selection.
UE obtains system information.

In particular, the UE in the RRC_IDLE state and the RRC_INACTIVE state may operate as shown in Table 1 below.

TABLE 1

| | UE procedure |
|---|---|
| 1^{st} step | a public land mobile network (PLMN) selection when a UE is |
| | switched on |
| 2^{nd} Step | cell (re)selection for searching a suitable cell |
| 3^{rd} Step | tune to its control channel (camping on the cell) |
| 4^{th} Step | Location registration and a RAN-based Notification Area (RNA) |
| | update |

### Uplink Power Control

In wireless communication systems, it may be necessary to increase or decrease the transmission power of a UE and/or a mobile device depending on situations. Controlling the transmission power of the UE and/or mobile device may be referred to as UL power control. For example, transmission power control may be applied to satisfy requirements (e.g., signal-to-noise ratio (SNR), bit error ratio (BER), block error ratio (BLER), etc.) of a BS (e.g., gNB, eNB, etc.).

The above-described power control may be performed according to an open-loop power control method and a closed-loop power control method.

Specifically, the open-loop power control method refers to a method of controlling transmission power without feedback from a transmitting device (e.g., BS, etc.) to a receiving device (e.g., UE, etc.) and/or feedback from the receiving device to the transmitting device. For example, the UE may receive a specific channel/signal (pilot channel/signal) from the BS and estimate the strength of received power based on the received channel/signal. Then, the UE may control the transmission power based on the strength of the estimated received power.

On the other hand, the closed-loop power control method refers to a method of controlling transmission power based on feedback from a transmitting device to a receiving device and/or feedback from the receiving device to the transmitting device. For example, the BS receives a specific channel/signal from the UE and determines an optimal power level of the UE based on a power level, SNR, BER, BLER, etc. which are measured based on the received specific channel/signal. The BS may transmit information (i.e., feedback) on the determined optimal power level to the UE on a control channel, and the UE may control the transmission power based on the feedback provided by the BS.

Hereinafter, power control methods for cases in which a UE and/or a mobile device perform UL transmission to a BS in a wireless communication system will be described in detail. Specifically, power control methods for transmission of: 1) a UL data channel (e.g., PUSCH); 2) a UL control channel (e.g., PUCCH); 3) an SRS; and/or 4) a random access channel (e.g., PRACH) will be described. In this case, a transmission occasion (i.e., transmission time unit) (i) for the PUSCH, PUCCH, SRS and/or PRACH may be defined by a slot index (n_s) in a frame with a system frame number (SFN), a first symbol(S) in a slot, the number of consecutive symbols (L), and the like.

### Power Control of UL Data Channel

Regarding power control of a UL data channel, a power control method will be described based on a case in which the UE performs PUSCH transmission, for convenience of description. However, the power control method is not limited to the PUSCH transmission, that is, the power control method may be extended and applied to other UL data channels supported in wireless communication systems.

For PUSCH transmission in an active UL bandwidth part (BWP) of a carrier (f) of a serving cell (c), the UE may calculate a linear power value of transmission power determined by Equation 1 below. Thereafter, the corresponding UE may control the transmission power by taking the calculated linear power value into consideration for the number of antenna ports and/or the number of SRS ports.

In particular, if the UE performs PUSCH transmission in the active UL BWP (b) of the carrier (f) of the serving cell (c) using a parameter set configuration based on index j and a PUSCH power control adjustment state based on index 1, the UE may determine PUSCH transmission power P_{PUSCH,b,f,c}(i,j,q_{d},l) (dBm) on a PUSCH transmission occasion (i) based on Equation 1 below.

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} \qquad [ Equation 1 ]$$

In Equation 1, index j denotes the index for an open-loop power control parameter (e.g., P_o, alpha (a), etc.), and a maximum of 32 parameter sets may be configured for each cell. Index q_d denotes the index of a DL RS resource for path loss (PL) measurement (e.g., PL_{b,f,c} (q_{d}), and a maximum of four measurements may be configured for each cell. Index 1 denotes the index of a closed-loop power control process, and a maximum of two processes may be configured for each cell.

In addition, P_o (e.g., P_{O_PUSCH, b,f,c}(j)) is a parameter broadcast as part of system information and may denote target received power of a receiver. The corresponding P_o value may be configured in consideration of UE throughput, cell capacity, noise and/or interference. Alpha (e.g., a_{b,f,c}(j) may denote a rate for compensating for PL. Alpha may have a value from 0 to 1, and full path loss compensation or fractional path loss compensation may be performed according to the configured value. In this case, the alpha value may be configured in consideration of interference between UEs and/or data rates. In addition, P_{CMAX, f,c}(i) may denote configured UE transmission (or transmit) power. For example, the configured UE transmission (or transmit) power may be interpreted as ‘configured maximum UE output power’ defined in 3GPP TS 38.101-1 and/or TS 38.101-2. M_{RBb,f,c}^{PUSCH}(i) may denote a PUSCH resource allocation bandwidth, which is expressed by the number of resource blocks (RBs) in the PUSCH transmission occasion based on an SCS (μ). f_{b,f,c}(i,l), which is related to PUSCH power control adjustment states, may be configured or indicated based on a TPC command field of DCI (e.g., DCI format 0_0, DCI format 0_1, DCI format 2_2, DCI format2_3, etc.).

In this case, a specific radio resource control (RRC) parameter (e.g., SRI-PUSCHPowerControl-Mapping, etc.) may indicate a linkage relationship between an SRS resource indicator (SRI) field of the DCI and the aforementioned indices: j, q_d, and 1. In other words, the above-mentioned indices j, 1, and q_d may be associated with a beam, a panel, and/or a spatial domain transmission filter based on specific information. Therefore, PUSCH transmission power control may be performed at the level of beams, panels, and/or spatial domain transmission filters.

The above-described parameters and/or information for PUSCH power control may be configured separately (independently) for each BWP. In this case, the corresponding parameters and/or information may be configured or indicated by higher layer signaling (RRC signaling, medium access control-control element (MAC-CE), etc.) and/or DCI. For example, the parameters and/or information for PUSCH power control may be provided by RRC signaling such as PUSCH-ConfigCommon, PUSCH-PowerControl, etc. One example of the configuration of PUSCH-ConfigCommon and PUSCH-PowerControl may be as follows, and a more detailed definition and the like for each parameter may refer to 3GPP TS Rel. 16 38.331, and the like.

| | |
|---|---|
| PUSCH-ConfigCommon ::= | SEQUENCE { |
| groupHoppingEnabledTransformPrecoding | ENUMERATED {enabled} |

OPTIONAL, --Need R

| | |
|---|---|
| pusch-TimeDomainAllocationList | PUSCH- |

TimeDomainResourceAllocationList
OPTIONAL, -- Need R

| | |
|---|---|
| msg3-DeltaPreamble | INTEGER (−1..6) |

OPTIONAL, -- Need R

| | |
|---|---|
| p0-NominalWithGrant | INTEGER (−202..24) |

```
OPTIONAL, -- Need R
  ...
  }
```

| | |
|---|---|
| PUSCH-PowerControl ::= | SEQUENCE { |
| tpc-Accumulation | ENUMERATED { disabled } |

OPTIONAL, -- Need S

| | |
|---|---|
| msg3-Alpha | Alpha |

OPTIONAL, -- Need S

| | |
|---|---|
| p0-NominalWithoutGrant | INTEGER (−202..24) |

OPTIONAL, -- Need M

| | |
|---|---|
| p0-AlphaSets | SEQUENCE (SIZE (1..maxNrofP0- |
| PUSCH-AlphaSets)) OF P0-PUSCH-AlphaSet | OPTIONAL, --Need M |
| pathlossReferenceRSToAddModList | SEQUENCE (SIZE |

```
(1..maxNrofPUSCH-PathlossReferenceRSs)) OF PUSCH-PathlossReferenceRS
  OPTIONAL, -- Need N
  pathlossReferenceRSToReleaseList SEQUENCE (SIZE
(1..maxNrofPUSCH-PathlossReferenceRSs)) OF PUSCH-PathlossReferenceRS-Id
  OPTIONAL, -- Need N
```

| | |
|---|---|
| twoPUSCH-PC-AdjustmentStates | ENUMERATED {twoStates} |

OPTIONAL, -- Need S

| | |
|---|---|
| deltaMCS | ENUMERATED {enabled} |

OPTIONAL, -- Need S

| | |
|---|---|
| sri-PUSCH-MappingToAddModList | SEQUENCE (SIZE |

```
(1..maxNrofSRI-PUSCH-Mappings)) OF SRI-PUSCH-PowerControl
  OPTIONAL, -- Need N
  sri-PUSCH-MappingToReleaseList SEQUENCE (SIZE (1..maxNrofSRI-
PUSCH-Mappings)) OF SRI-PUSCH-PowerControlId
  OPTIONAL, -- Need N
  }
```

The UE may determine or calculate the PUSCH transmission power according to the above-described method and transmit the PUSCH based on the determined or calculated PUSCH transmission power.

### Power Control of UL Control Channel

Regarding power control of a UL control channel, a power control method will be described based on a case in which the UE performs PUCCH transmission, for convenience of description. However, the power control method is not limited to the PUCCH transmission, that is, the power control method may be extended and applied to other UL control channels supported in wireless communication systems.

If the UE performs PUCCH transmission in an active UL BWP (b) of a carrier (f) of a primary cell (or secondary cell) (c) using a PUCCH power control adjustment state based on index 1, the UE may determine PUCCH transmission power P_{PUCCH,b,f,c} (i, qᵤ, q_{d}, l) (dBm) on a PUCCH transmission occasion (i) based on Equation 2 below.

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix}\end{matrix} \} \qquad [ Equation 2 ]$$

In Equation 2, q_u denotes the index of an open-loop power control parameter (e.g., P_o, etc.), and a maximum of 8 parameter values may be configured for each cell. Index q_d denotes the index of a DL RS resource for PL measurement (e.g., PL_{b,f,c}(q_{d})), and a maximum of four measurements may be configured for each cell. Index 1 denotes the index of a closed-loop power control process, and a maximum of two processes may be configured for each cell.

In addition, P_o (e.g., P_{O_PUOCH,b,f,c}(qᵤ) is a parameter broadcast as part of system information and may denote target received power of a receiver. The corresponding P_o value may be configured in consideration of UE throughput, cell capacity, noise and/or interference. In addition, P_{CMAX,f,c} (i) may denote configured UE transmission (or transmit) power. For example, the configured UE transmission (or transmit) power may be interpreted as ‘configured maximum UE output power’ defined in 3GPP TS 38.101-1 and/or TS 38.101-2. M_{RBb,f,c}^{PUCCH}(i) may denote a PUCCH resource allocation bandwidth, which is expressed by the number of RBs in the PUCCH transmission occasion based on an SCS (μ). Delta functions (e.g., Δ_{F_PUCCH} (F), Δ_{TF,b,f,c} (i), etc.) may be configured in consideration of PUCCH formats (e.g., PUCCH formats 0, 1, 2, 3, 4, etc.). g_{b,f,c} (i,l), which is related to PUCCH power control adjustment states, may be configured or indicated based on a TPC command field of DCI received or detected by the UE (e.g., DCI format 1_0, DCI format 1_1, DCI format 2_2, etc.).

In this case, a specific RRC parameter (e.g., PUCCH-SpatialRelationInfo, etc.) and/or a specific MAC-CE command (e.g., PUCCH spatial relation Activation/Deactivation, etc.) may be used to activate or deactivate a linkage relationship between PUCCH resources and the aforementioned indices q_u, q_d, and l. For example, the PUCCH spatial relation Activation/Deactivation command of the MAC-CE may activate or deactivate the linkage relationship between the PUCCH resources and the aforementioned indices q_u, q_d, and l based on the RRC parameter PUCCH-SpatialRelationInfo. In other words, the above-described indices q_u, q_d, and l may be associated with a beam, a panel, and/or a spatial domain transmission filter based on specific information. Therefore, PUCCH transmission power control may be performed at the level of beams, panels, and/or spatial domain transmission filters.

The above-described parameters and/or information for PUCCH power control may be configured separately (independently) for each BWP. In this case, the corresponding parameters and/or information may be configured or indicated by higher layer signaling (RRC signaling, MAC-CE, etc.) and/or DCI. For example, the parameters and/or information for PUCCH power control may be provided by RRC signaling such as PUCCH-ConfigCommon, PUCCH-PowerControl, etc. One example of the configuration of PUCCH-ConfigCommon and PUCCH-PowerControl may be as follows, and a more detailed definition and the like for each parameter may refer to 3GPP TS Rel. 16 38.331, and the like.

| | |
|---|---|
| PUCCH-ConfigCommon ::= | SEQUENCE { |
| pucch-ResourceCommon | INTEGER (0..15) |

OPTIONAL, -- Cond InitialBWP-Only

| | |
|---|---|
| pucch-GroupHopping | ENUMERATED { neither, enable, |

disable },

| | |
|---|---|
| hoppingId | INTEGER (0..1023) |

OPTIONAL, -- Need R

| | |
|---|---|
| p0-nominal | INTEGER (−202..24) |

```
OPTIONAL, -- Need R
  ...
  }
```

| | |
|---|---|
| PUCCH-PowerControl ::= | SEQUENCE { |
| deltaF-PUCCH-f0 | INTEGER (−16..15) |

OPTIONAL, -- Need R

| | |
|---|---|
| deltaF-PUCCH-f1 | INTEGER (−16..15) |

OPTIONAL, -- Need R

| | |
|---|---|
| deltaF-PUCCH-f2 | INTEGER (−16..15) |

OPTIONAL, -- Need R

| | |
|---|---|
| deltaF-PUCCH-f3 | INTEGER (−16..15) |

OPTIONAL, -- Need R

| | |
|---|---|
| deltaF-PUCCH-f4 | INTEGER (−16..15) |

OPTIONAL, -- Need R

| | |
|---|---|
| p0-Set | SEQUENCE (SIZE |
| (1..maxNrofPUCCH-P0-PerSet)) OF P0-PUCCH | OPTIONAL, -- |

Need M

| | |
|---|---|
| pathlossReferenceRSs | SEQUENCE (SIZE |

(1..maxNrofPUCCH-PathlossReferenceRSs)) OF PUCCH-PathlossReferenceRS
OPTIONAL, -- Need M

| | |
|---|---|
| twoPUCCH-PC-AdjustmentStates | ENUMERATED [twoStates] |

```
OPTIONAL, -- Need S
  ...
  }
```

| | |
|---|---|
| P0-PUCCH ::= | SEQUENCE { |
| p0-PUCCH-Id | P0-PUCCH-Id, |
| p0-PUCCH-Value | INTEGER (−16..15) |

}

| | |
|---|---|
| P0-PUCCH-Id ::= | INTEGER (1..8) |
| PUCCH-PathlossReferenceRS ::= | SEQUENCE { |
| pucch-PathlossReferenceRS-Id | PUCCH- |

PathlossReferenceRS-Id,

| | |
|---|---|
| referenceSignal | CHOICE { |
| ssb-Index | SSB-Index, |
| csi-RS-Index | NZP-CSI-RS-ResourceId |

```
  }
  }
```

The UE may determine or calculate the PUCCH transmission power according to the above-described method and transmit the PUCCH based on the determined or calculated PUCCH transmission power.

### Power Control of SRS

In relation to SRS transmission in an active UL BWP of a carrier (f) of a serving cell (c), the UE may calculate a linear power value of transmission power determined by Equation 3 below. Thereafter, the UE may control the transmission power by equally dividing the calculated linear power value over antenna port(s) configured for the SRS.

Specifically, when the UE performs SRS transmission in an active UL BWP (b) of the carrier (f) of the serving cell (c) using an SRS power control adjustment state based on index 1, the UE may determine SRS transmission power P_{SRS,b,f,c} (i, qₛ, l) (dBm) on an SRS transmission occasion (i) based on Equation 3 below.

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} \qquad [ Equation 3 ]$$

In Equation 3, q_s denotes the index of an open-loop power control parameter (e.g., P_o, alpha ( ) a DL RS resource for a path loss (PL) measurement (e.g., PL_{b,f,c} (q_{d})), etc.), which may be configured for SRS resource set. Index 1 denotes the index of a closed-loop power control process, and the corresponding index may be configured independently of a PUSCH or configured in relation to the PUSCH. If SRS power control is not related to the PUSCH, the maximum number of closed-loop power control processes for the SRS may be 1.

In addition, P_o (e.g., P_{O_SRS, b,f,c} (qₛ)) is a parameter broadcast as part of system information and may denote target received power of the receiver. The corresponding P_o value may be configured in consideration of UE throughput, cell capacity, noise and/or interference, etc. Alpha (e.g., a_{SRSb,f,c}(qₛ) may denote a rate for compensating for PL. Alpha may have a value from 0 to 1, and full path loss compensation or fractional path loss compensation may be performed according to the configured value. In this case, the alpha value may be configured in consideration of interference between UEs and/or data rates. In addition, P_{CMAX, f,c} (i) may denote configured UE transmission power. For example, the configured UE transmission power may be interpreted as ‘configured maximum UE output power’ defined in 3GPP TS 38.101-1 and/or TS 38.101-2. M_{SRSb,f,c}(i) may denote an SRS resource allocation bandwidth, which is expressed by the number of RBs in the SRS transmission occasion based on an SCS (μ) In addition, h_{b,f,c}(ij), which is related to SRS power control adjustment states, may be configured or indicated based on a TPC command field of DCI received or detected by the UE (e.g., DCI format 2_3, etc.) and/or an RRC parameter (e.g., srs-PowerControlAdjustmentStates, etc.).

A resource for SRS transmission may be applied as a reference for the BS and/or UE to determine a beam, a panel, and/or a spatial domain transmission filter. Thus, SRS transmission power control may be performed in units of beams, panels, and/or spatial domain transmission filters.

The above-described parameters and/or information for SRS power control may be configured separately (independently) for each BWP. In this case, the corresponding parameters and/or information may be configured or indicated by higher layer signaling (e.g., RRC signaling, MAC-CE, etc.) and/or DCI. For example, the parameters and/or information for SRS power control may be provided by RRC signaling such as SRS-Config, SRS-TPC-CommandConfig, etc. One example of the configuration of SRS-Config and SRS-TPC-CommandConfig may be as follows, and a more detailed definition for each parameter may refer to 3GPP TS Rel. 16 38.331, and the like.

| | |
|---|---|
| SRS-Config ::= | SEQUENCE { |
| srs-ResourceSetToReleaseList | SEQUENCE |

| | |
|---|---|
| (SIZE(1..maxNrofSRS-ResourceSets)) OF SRS-ResourceSetId | OPTIONAL, - |

- Need N

| | |
|---|---|
| srs-ResourceSetToAddModList | SEQUENCE |

| | |
|---|---|
| (SIZE(1..maxNrofSRS-ResourceSets)) OF SRS-ResourceSet | OPTIONAL, - |

- Need N

| | |
|---|---|
| srs-ResourceToReleaseList | SEQUENCE |

| | |
|---|---|
| (SIZE(1..maxNrofSRS-Resources)) OF SRS-ResourceId | OPTIONAL, |

-- Need N

| | |
|---|---|
| srs-ResourceToAddModList | SEQUENCE |

| | |
|---|---|
| (SIZE(1..maxNrofSRS-Resources)) OF SRS-Resource | OPTIONAL, |

-- Need N

| | |
|---|---|
| tpc-Accumulation | ENUMERATED {disabled } |

OPTIONAL, -- Need S
...,

| | |
|---|---|
| SRS-ResourceSet ::= | SEQUENCE{ |
| srs-ResourceSetId | SRS-ResourceSetId, |
| srs-ResourceIdList | SEQUENCE |

| | |
|---|---|
| (SIZE(1..maxNrofSRS-ResourcesPerSet)) OF SRS-ResourceId | OPTIONAL, -- |

Cond Setup

| | |
|---|---|
| resourceType | CHOICE { |
| aperiodic | SEQUENCE { |
| aperiodicSRS-ResourceTrigger | INTEGER (1..maxNrofSRS- |

TriggerStates-1).

| | |
|---|---|
| csi-RS | NZP-CSI-RS-ResourceId |

OPTIONAL, -- Cond NonCodebook

| | |
|---|---|
| slotOffset | INTEGER (1..32) |

```
OPTIONAL, -- Need S
  ...,
  [[
```

| | |
|---|---|
| aperiodicSRS-ResourceTriggerList | SEQUENCE |

(SIZE(1..maxNrofSRS-TriggerStates-2))

| | | |
|---|---|---|
| OF INTEGER (1..maxNrofSRS-TriggerStates-1) | OPTIONAL | -- Need M |

```
  ]]
  },
```

| | |
|---|---|
| semi-persistant | SEQUENCE { |
| associatedCSI-RS | NZP-CSI-RS-ResourceId |

```
OPTIONAL, -- Cond NonCodebook
  ...
  ],
```

| | |
|---|---|
| periodic | SEQUENCE { |
| associatedCSI-RS | NZP-CSI-RS-ResourceId |

```
OPTIONAL, -- Cond NonCodebook
  ...
  }
  },
```

| | |
|---|---|
| usage | ENUMERATED |

[beamManagement, codebook, nonCodebook, antennaSwitching],

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | PathlossReferenceRS-Config |

OPTIONAL, -- Need M,

| | |
|---|---|
| srs-PowerControlAdjustmentStates | ENUMERATED { sameAsFci2, |
| separateClosedLoop} OPTIONAL, | -- Need S |

```
  ..,
  [[
```

| | |
|---|---|
| pathlossReferenceRS-List-r16 | SEQUENCE |

```
(SIZE(1..maxNrofSRS-PathlossReferenceRS-r16-1)) OF PathlossReferenceRS-
Config
  OPTIONAL -- Need M
  ]]
  }
```

| | |
|---|---|
| PathlossReferenceRS-Config ::= | CHOICE { |
| ssb-Index | SSB-index, |
| csi-RS-Index | NZP-CSI-RS-ResourceId |

}

| | |
|---|---|
| SRS-PosResourceSet-r16 ::= | SEQUENCE { |
| srs-PosResourceSetId-r16 | SRS-PosResourceSetId- |

r16,

| | |
|---|---|
| srs-PosResourceIdList-r16 | SEQUENCE |

(SIZE(1..maxNrofSRS-ResourcesPerSet)) OF SRS-PosResourceId-r16
OPTIONAL, -- Cond Setup

| | |
|---|---|
| resourceType-r16 | CHOICE [ |
| aperiodic-r16 | SEQUENCE { |
| aperiodicSRS-ResourceTriggerList-r16 | SEQUENCE |

(SIZE(1..maxNrofSRS-TriggerStates-1))

| | |
|---|---|
| OF INTEGER (1..maxNrofSRS-TriggerStates-1) | OPTIONAL, -- Need M |
| slotOffset-r16 | INTEGER (1..32) |

```
OPTIONAL, -- Need S
  ...
  },
```

| | |
|---|---|
| semi-persistent-r16 | SEQUENCE { |

```
  ...
  },
```

| | |
|---|---|
| periodic-r16 | SEQUENCE { |

```
  ...
  }
  },
```

| | |
|---|---|
| alpha-r16 | Alpha |

OPTIONAL, -- Need S

| | |
|---|---|
| p0-r16 | INTEGER (−202..24) |

OPTIONAL, -- Cond Setup

| | |
|---|---|
| pathlossReferenceRS-Pos-r16 | CHOICE { |
| ssb-index-16 | SSB-Index |
| csi-RS-Index-r16 | NZP-CSI-RS-ResourceId, |
| ssb-r16 | SSB-InfoNcell-r16, |
| di-PRS-r16 | DL-PRS-Info-r16 |

}
OPTIONAL, -- Need M

| ... | |
|---|---|
| } | |
| SRS-TPC-CommandConfig ::= | SEQUENCE { |
| startingBitOfFormat2-3 | INTEGER (1..31) |
| OPTIONAL, -- Need R | |
| fieldTypeFormat2-3 | INTEGER (0..1) |
| OPTIONAL, -- Need R | |
| ..., | |
| [[ | |
| startingBitOfFormat2-3SUL | INTEGER (1..31) |

```
OPTIONAL -- Need R
  ]]
  }
```

The UE may determine or calculate the SRS transmission power according to the above-described method and transmit the SRS based on the determined or calculated SRS transmission power.

### Power Control of Random Access Channel

When the UE performs PRACH transmission in an active UL BWP (b) of a carrier (f) of a serving cell (c), the UE may determine PRACH transmission power P_{PRACH, b,f,c}(i) (dBm) on a PRACH transmission occasion (i) based on Equation 4 below.

$${P}_{PRACH , b , f , c} ( i ) = min \{ {P}_{CMAX , f , c} ( i ) , {P}_{PRACH , target , f , c} + {PL}_{b , f , c} \} \qquad [ Equation 4 ]$$

In Equation 4, P_{CMAX, f,c} (i) may denote configured UE transmission (or transmit) power. For example, the configured UE transmission (or transmit) power may be interpreted as ‘configured maximum UE output power’ defined in 3GPP TS 38.101-1 and/or TS 38.101-2. In addition, P_{PRACH, target, fc} denotes PRACH target reception power provided through higher layer signaling (e.g., RRC signaling, MAC-CE, etc.) for the active UL BWP. PL_{b,f,c} denotes PL for the active UL BWP, which may be determined based on a DL RS related to PRACH transmission in the active DL BWP of the serving cell (c). For example, the UE may determine PL related to PRACH transmission based on a synchronization signal/physical broadcast channel (SS/PBCH) block related to the PRACH transmission.

The above-described parameters and/or information for PRACH power control may be configured separately (independently) for each BWP. In this case, the corresponding parameters and/or information may be configured or indicated by higher layer signaling (RRC signaling, MAC-CE, etc.) and/or DCI. For example, the parameters and/or information for PRACH power control may be provided by RRC signaling such as RACH-ConfigGeneric, etc. One example of the configuration of RACH-ConfigGeneric may be as follows, and a more detailed definition and the like for each parameter may refer to 3GPP TS Rel. 16 38.331, and the like.

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks- |

1),

| | |
|---|---|
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, |

n50, n100, n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, |

```
  sl40, sl80},
      ...,
      [[
```

| | |
|---|---|
| ra-ResponseWindow-r16 | ENUMERATED {sl1, sl2, sl4, sl8, sl10, sl20, sl40, |

sl60, sl80, sl160} OPTIONAL, -- Need R

| | |
|---|---|
| prach-ConfigurationIndex-v16xy | INTEGER (256..262) |

```
  OPTIONAL -- Need R
      ]]
}
```

The UE may determine or calculate the PRACH transmission power according to the above-described method and transmit the PRACH based on the determined or calculated PRACH transmission power.

### Priorities for Transmission Power Control

Hereinafter, a method of controlling the transmission power of a UE will be described in consideration of single cell operation in a carrier aggregation environment or single cell operation in multi-UL carrier (e.g., two carriers) environment.

In this case, if the total UE transmission (or transmit) power of UL transmissions (e.g., PUSCH, PUCCH, SRS, and PRACH transmissions described above in (1) to (4)) on transmission occasions (i) exceeds the linear value of configured UE transmission (or transmit) power (e.g., P_{CMAX} (i), the UE may be configured to allocate UL transmission power according to priorities (priority order). For example, the configured UE transmission (or transmit) power may mean ‘configured maximum UE output power’ (e.g., P_{CMAX}(i)) defined in 3GPP TS 38.101-1 and/or TS 38.101-2.

In this case, the priorities for transmission power control may be configured or defined in the following order.
PRACH transmission on Primary Cell (PCell)
PUCCH for hybrid automatic repeat and request-acknowledgement (HARQ-ACK) information and/or scheduling request (SR) or PUSCH for HARQ-ACK information
PUCCH or PUSCH for channel state information (CSI)
PUSCH for neither HARQ-ACK information nor CSI
SRS transmission or PRACH transmission in serving cell other than PCell (however, an aperiodic SRS has a higher priority than a semi-persistent SRS and/or periodic SRS)

The UE may control the total transmission power to be less than or equal to the linear value of the configured UE transmission (or transmit) power in each symbol of the transmission occasion (i) based on the power allocation according to the priority order as described above. For example, to this end, the UE may be configured to scale and/or drop the power of UL transmission with a low priority. In this case, details of scaling and/or dropping may be configured or defined according to UE implementation.

As a particular example, for transmissions with the same priority in carrier aggregation, the UE may assume that transmission in a Pcell has a higher priority than transmission in a secondary cell (Scell). Additionally/alternatively, for transmissions with the same priority in multiple UL carriers (e.g., two UL carriers), the UE may assume a carrier on which PUCCH transmission is configured to have a high priority. In addition, if PUCCH transmission is not configured on any carriers, the UE may assume that transmission on a non-supplementary UL carrier has a high priority.

### Transmission Power Control Procedure

FIG. 3 is a diagram illustrating an exemplary procedure for controlling UL transmission power to which various embodiments are applicable.

First, a UE may receive parameters and/or information related to transmission power (Tx power) from a BS (1005). In this case, the UE may receive the corresponding parameters and/or information through higher layer signaling (e.g., RRC signaling, MAC-CE, etc.). For example, for PUSCH transmission, PUCCH transmission, SRS transmission, and/or PRACH transmission, the UE may receive the above-described parameters and/or information related to transmission power control.

The UE may receive a TPC command related to transmission power from the BS (1005). In this case, the UE may receive the corresponding TPC command through lower layer signaling (e.g., DCI). For example, for PUSCH transmission, PUCCH transmission, and/or SRS transmission, the UE may receive information on a TPC command to be used for determining a power control adjustment state, etc. in a TPC command field of a predefined DCI format as described above. However, the corresponding step may be omitted in PRACH transmission.

The UE may determine (or calculate) transmission power for UL transmission based on the parameters, information, and/or TPC command received from the BS (1015). For example, the UE may determine PUSCH transmission power, PUCCH transmission power, SRS transmission power, and/or PRACH transmission power according to the above-described methods (e.g., Equations 1 to 4, etc.). Additionally/alternatively, when two or more UL channels and/or signals need to be transmitted together as in carrier aggregation, the UE may determine the transmission power for UL transmission in consideration of the above-described priorities.

The UE may perform transmission of one or more UL channels and/or signals (e.g., PUSCH, PUCCH, SRS, PRACH, etc.) to the BS based on the determined (or calculated) transmission power (1020).

### 2. Positioning

Positioning may refer to determining the geographical position and/or velocity of the UE based on measurement of radio signals. Location information may be requested by and reported to a client (e.g., an application) associated with to the UE. The location information may also be requested by a client within or connected to a core network. The location information may be reported in standard formats such as formats for cell-based or geographical coordinates, together with estimated errors of the position and velocity of the UE and/or a positioning method used for positioning.

### Positioning Protocol Configuration

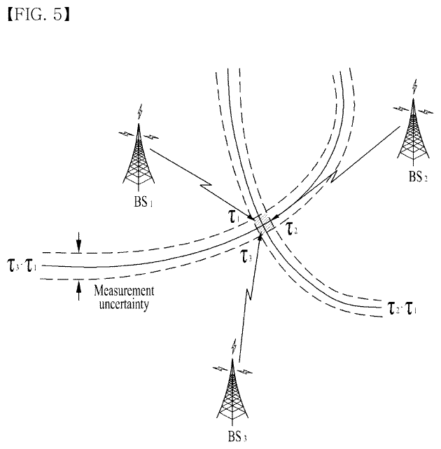

FIG. 4 is a diagram illustrating an exemplary positioning protocol configuration for positioning a UE, to which the embodiment is applicable.

Referring to FIG. 4, an LTE positioning protocol (LPP) may be used as a point-to-point protocol between a location server (E-SMLC and/or SLP and/or LMF) and a target device (UE and/or SET), for positioning the target device using position-related measurements obtained from one or more reference resources. The target device and the location server may exchange measurements and/or location information based on signal A and/or signal B over the LPP.

NRPPa may be used for information exchange between a reference source (access node and/or BS and/or TP and/or NG-RAN node) and the location server.

The NRPPa protocol may provide the following functions.
E-CID Location Information Transfer. This function allows the reference source to exchange location information with the LMF for the purpose of E-CID positioning.
OTDOA Information Transfer. This function allows the reference source to exchange information with the LMF for the purpose of OTDOA positioning.
Reporting of General Error Situations. This function allows reporting of general error situations, for which function-specific error messages have not been defined.

### Positioning Measurement Method

Positioning methods supported in the NG-RAN may include a GNSS, an OTDOA, an E-CID, barometric sensor positioning, WLAN positioning, Bluetooth positioning, a TBS, uplink time difference of arrival (UTDOA) etc. Although any one of the positioning methods may be used for UE positioning, two or more positioning methods may be used for UE positioning.

### OTDOA (Observed Time Difference of Arrival)

FIG. 5 is a diagram illustrating an observed time difference of arrival (OTDOA) positioning method, to which the embodiment is applicable;

The OTDOA positioning method uses time measured for DL signals received from multiple TPs including an eNB, an ng-eNB, and a PRS-only TP by the UE. The UE measures time of received DL signals using location assistance data received from a location server. The position of the UE may be determined based on such a measurement result and geographical coordinates of neighboring TPs.

The UE connected to the gNB may request measurement gaps to perform OTDOA measurement from a TP. If the UE is not aware of an SFN of at least one TP in OTDOA assistance data, the UE may use autonomous gaps to obtain an SFN of an OTDOA reference cell prior to requesting measurement gaps for performing reference signal time difference (RSTD) measurement.

Here, the RSTD may be defined as the smallest relative time difference between two subframe boundaries received from a reference cell and a measurement cell. That is, the RSTD may be calculated as the relative time difference between the start time of a subframe received from the measurement cell and the start time of a subframe from the reference cell that is closest to the subframe received from the measurement cell. The reference cell may be selected by the UE.

For accurate OTDOA measurement, it is necessary to measure time of arrival (ToA) of signals received from geographically distributed three or more TPs or BSs. For example, ToA for each of TP 1, TP 2, and TP 3 may be measured, and RSTD for TP 1 and TP 2, RSTD for TP 2 and TP 3, and RSTD for TP 3 and TP 1 are calculated based on three ToA values. A geometric hyperbola is determined based on the calculated RSTD values and a point at which curves of the hyperbola cross may be estimated as the position of the UE. In this case, accuracy and/or uncertainty for each ToA measurement may occur and the estimated position of the UE may be known as a specific range according to measurement uncertainty.

For example, RSTD for two TPs may be calculated based on Equation 5 below.

$$RSTDi {,}_{1} \frac{\sqrt{{( {x}_{t} - {x}_{i} )}^{2} + {( {y}_{t} - {y}_{i} )}^{2}}}{c} - \frac{\sqrt{{( {x}_{t} - {x}_{1} )}^{2} + {( {y}_{t} - {y}_{1} )}^{2}}}{c} + ( {T}_{i} - {T}_{1} ) + ( {n}_{i} - {n}_{1} ) \qquad [ Equation 5 ]$$

In Equation 5, c is the speed of light, {xt, yt} are (unknown) coordinates of a target UE, {xi, yi} are (known) coordinates of a TP, and {x1, y1} are coordinates of a reference TP (or another TP). Here, (Ti-T1) is a transmission time offset between two TPs, referred to as “real time differences” (RTDs), and ni and nl are UE ToA measurement error values.

### E-CID (Enhanced Cell ID)

In a cell ID (CID) positioning method, the position of the UE may be measured based on geographical information of a serving ng-eNB, a serving gNB, and/or a serving cell of the UE. For example, the geographical information of the serving ng-eNB, the serving gNB, and/or the serving cell may be acquired by paging, registration, etc.

The E-CID positioning method may use additional UE measurement and/or NG-RAN radio resources in order to improve UE location estimation in addition to the CID positioning method. Although the E-CID positioning method partially may utilize the same measurement methods as a measurement control system on an RRC protocol, additional measurement only for UE location measurement is not generally performed. In other words, an additional measurement configuration or measurement control message may not be provided for UE location measurement. The UE does not expect that an additional measurement operation only for location measurement will be requested and the UE may report a measurement value obtained by generally measurable methods.

For example, the serving gNB may implement the E-CID positioning method using an E-UTRA measurement value provided by the UE.

Measurement elements usable for E-CID positioning may be, for example, as follows.
UE measurement: E-UTRA reference signal received power (RSRP), E-UTRA reference signal received quality (RSRQ), UE E-UTRA reception (Rx)-transmission (Tx) time difference, GERAN/WLAN reference signal strength indication (RSSI), UTRAN common pilot channel (CPICH) received signal code power (RSCP), and/or UTRAN CPICH Ec/Io
E-UTRAN measurement: ng-eNB Rx-Tx time difference, timing advance (TADV), and/or AoA

Here, TADV may be divided into Type 1 and Type 2 as follows.

TADV Type 1=(ng-eNB Rx-Tx time difference)+ (UE E-UTRA Rx-Tx time difference)

TADV Type 2=ng-eNB Rx-Tx time difference

AoA may be used to measure the direction of the UE. AoA is defined as the estimated angle of the UE counterclockwise from the eNB/TP. In this case, a geographical reference direction may be north. The eNB/TP may use a UL signal such as an SRS and/or a DMRS for AoA measurement. The accuracy of measurement of AoA increases as the arrangement of an antenna array increases. When antenna arrays are arranged at the same interval, signals received at adjacent antenna elements may have constant phase rotate.

### UTDOA (Uplink Time Difference of Arrival)

UTDOA is a method of determining a location of a UE by estimating an arrival time of SRS. When calculating the estimated SRS arrival time, the location of the UE may be estimated through a difference in arrival time from another cell (or a base station/TP) by using a serving cell as a reference cell. In order to implement the UTDOA, an E-SMLC may indicate a serving cell of a target UE to instruct SRS transmission to the target UE. In addition, the E-SMLC may provide configuration such as periodicity/aperiodicity, bandwidth, frequency/group/sequence hopping, and the like of SRS.

### Multi RTT (Multi-Cell RTT)

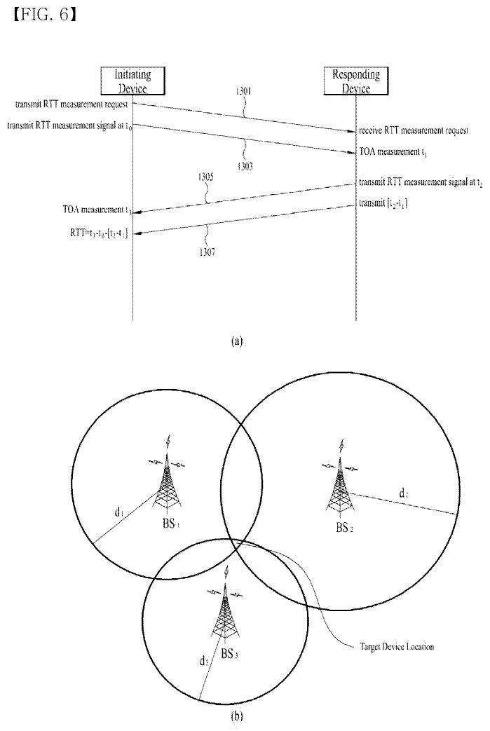

FIG. 6 is a diagram illustrating an exemplary multi-round trip time (multi-RTT) positioning method to which the embodiment is applicable.

Referring to FIG. 6(a), an exemplary RTT procedure is illustrated, in which an initiating device and a responding device perform ToA measurements, and the responding device provides ToA measurements to the initiating device, for RTT measurement (calculation). The initiating device may be a TRP and/or a UE, and the responding device may be a UE and/or a TRP.

In operation 1301 according to the embodiment, the initiating device may transmit an RTT measurement request, and the responding device may receive the RTT measurement request.

In operation 1303 according to the embodiment, the initiating device may transmit an RTT measurement signal at t0 and the responding device may acquire a ToA measurement t1.

In operation 1305 according to the embodiment, the responding device may transmit an RTT measurement signal at t2 and the initiating device may acquire a ToA measurement t3.

In operation 1307 according to the embodiment, the responding device may transmit information about [t2-t1], and the initiating device may receive the information and calculate an RTT by Equation 6. The information may be transmitted and received based on a separate signal or in the RTT measurement signal of operation 1305.

$$RTT = {t}_{3} - {t}_{0} - [ {t}_{2} - {t}_{1} ] \qquad [ Equation 6 ]$$

Referring to FIG. 6(b), an RTT may correspond to a double-range measurement between two devices. Positioning estimation may be performed from the corresponding information, and multilateration may be used for the positioning estimation d1, d2, and d3 may be determined based on the measured RTT, and the location of a target device may be determined to be the intersection of the circumferences of circles with radiuses of d1, d2, and d3, in which BS1, BS2, and BS3 (or TRPs) are centered respectively.

### Sounding Procedure

In a wireless communication system to which the embodiment is applicable, an SRS for positioning may be used.

An SRS-Config information element (IE) may be used to configure SRS transmission. (A list of) SRS resources and/or (a list of) SRS resource sets may be defined, and each resource set may be defined as a set of SRS resources.

The SRS-Config IE may include configuration information on an SRS (for other purposes) and configuration information on an SRS for positioning separately. For example, configuration information on an SRS resource set for the SRS (for other purposes) (e.g., SRS-ResourceSet) and configuration information on an SRS resource set for the SRS for positioning (e.g., SRS-PosResourceSet) may be included separately. In addition, configuration information on an SRS resource for the SRS (for other purposes) (e.g., SRS-ResourceSet) and configuration information on an SRS resource for the SRS for positioning (e.g., SRS-PosResource) may be included separately.

An SRS resource set for positioning may include one or more SRS resources for positioning. Configuration information on the SRS resource set for positioning may include: information on an identifier (ID) that is assigned/allocated/related to the SRS resource set for positioning; and information on an ID that is assigned/allocated/related to each of the one or more SRS resources for positioning. For example, configuration information on an SRS resource for positioning may include an ID assigned/allocated/related to a UL resource. In addition, each SRS resource/SRS resource set for positioning may be identified based on each ID assigned/allocated/related thereto.

The SRS may be configured periodically/semi-persistently/aperiodically.

An aperiodic SRS may be triggered by DCI. The DCI may include an SRS request field.

Table 6 shows an exemplary SRS request field.

TABLE 2

| | Triggered aperiodic SRS | |
|---|---|---|
| | resource set(s) for DCI format | |
| | 0_1, 0_2, 1_1, 1_2, and 2_3 | Triggered aperiodic SRS resource |
| | configured with higher layer | set(s) for DCI format 2_3 configured |
| Value of SRS | parameter srs-TPC-PDCCH- | with higher layer parameter srs-TPC- |
| request field | Group set to ‘typeB’ | PDCCH-Group set to ‘typeA’ |
| 00 | No aperiodic SRS resource set | No aperiodic SRS resource set triggered |
| | triggered | |
| 01 | SRS resource set(s) configured | SRS resource set(s) configured with |
| | by SRS•ResourceSet with higher | higher layer parameter usage in SRS- |
| | layer parameter aperiodicSRS- | ResourceSet set to ‘antennaSwitching’ |
| | ResourceTrigger set to 1 or an | and resourceType in SRS-ResourceSet |
| | entry in aperodicSRS- | set to ‘aperiodic’ of a 1^{st} set of serving |
| | ResourceTriggerList set to 1 | cells configured by higher layers |
| | SRS resource set(s) configured | |
| | by SRS-PosResourceSet with | |
| | an entry in aperiodicSRS- | |
| | ResourceTriggerList set to 1 | |
| | when triggered by DCI formats | |
| | 0_1, 0_2, 1_1, and 1_2 | |
| 10 | SRS resource set(s) configured | SRS resource set(s) configured with |
| | by SRS-ResourceSet with higher | higher layer parameter usage in SRS- |
| | layer parameter aperiodicSRS- | ResourceSet set to ‘antennaSwitching’ |
| | ResourceTrigger set to 2 or an | and resourceType in SRS-ResourceSet |
| | entry in aperiodicSRS- | set to ‘aperiodic’ for a 2^{nd} set of serving |
| | ResourceTriggerList set to 2 | cells configured by higher layers |
| | SRS resource set(s) configured | |
| | by SRS-PosResourceSet with | |
| | an entry in aperiodicSRS- | |
| | ResourceTriggerList set to 2 | |
| | when triggered by DCI formats | |
| | 0_1, 0_2, 1_1, and 1_2 | |
| 11 | SRS resource set(s) configured | SRS resource set(s) configured with |
| | by SRS-ResourceSet with higher | higher layer parameter usage in SRS- |
| | layer parameter aperiodicSRS- | ResourceSet set to ‘antennaSwitching’ |
| | ResourceTrigger set to 3 or an | and resourceType in SRS-ResourceSet |
| | entry in aperiodicSRS- | set to ‘aperiodic’ for a 3^{rd} set of serving |
| | ResourceTriggerList set to 3 | cells configured by higher layers |
| | SRS resource set(s) configured | |
| | by SRS-PosResourceSet with | |
| | an entry in aperiodicSRS- | |
| | ResourceTriggerList set to 3 | |
| | when triggered by DCI formats | |
| | 0_1, 0_2, 1_1, and 1_2 | |

In Table 2 srs-TPC-PDCCH-Group is a parameter for setting the triggering type for SRS transmission to type A or type B, aperiodicSRS-ResourceTriggerList is a parameter for configuring an additional list of DCI code points where the UE needs to transmit the SRS according to the SRS resource set configuration, aperiodicSRS-ResourceTrigger is a parameter for configuring a DCI code point where the SRS needs to be transmitted according to the SRS resource set configuration, and resourceType is a parameter for configuring (periodic/semi-static/aperiodic) time domain behavior of the SRS resource configuration.

### One Embodiment

A detailed description will be given of the embodiment based on the above technical ideas. The afore-described contents of Section 1 and Section 2 are applicable to the embodiment described below. For example, operations, functions, terminologies, and so on which are not defined in the embodiment may be performed and described based on Section 1 and Section 2.

Symbols/abbreviations/terms used in the description of the embodiment may be defined as follows.

$$A / B / C : A and / or B and / or C$$

SRS: sounding reference signal. According to the embodiment, the SRS may be used for UL channel estimation and positioning measurement using multiple-input multiple-output (MIMO). In other words, according to the embodiment, the SRS may include a normal SRS and a positioning SRS. According to the embodiment, the positioning SRS may be understood as a UL RS configured for positioning of the UE and/or used for positioning of the UE. According to the embodiment, the normal SRS, which is contrasted with the positioning SRS, may be understood as a UL RS configured for UL channel estimation and/or used for UL channel estimation (and/or configured for UL channel estimation and positioning and/or used for UL channel estimation and positioning). According to the embodiment, the positioning SRS may also be called an SRS for positioning. In a description of the embodiment, terms such as the positioning SRS and the SRS for positioning may be used interchangeably and may be understood as having the same meaning. According to the embodiment, the normal SRS may also be referred to as a legacy SRS, a MIMO SRS, or an SRS for MIMO. In a description of the embodiment, terms such as normal SRS, legacy SRS, MIMO SRS, and SRS for MIMO may be used interchangeably and may be understood as having the same meaning. For example, the normal SRS and the positioning SRS may be separately configured/indicated. For example, the normal SRS and the positioning SRS may be configured/indicated by different IEs of higher layers. For example, the normal SRS may be configured based on an SRS-resource. For example, the positioning SRS may be configured based on an SRS-PosResource.
TPC: Transmit Power Control
TRP: transmission and reception point (TP: transmission point)

In the description of the embodiment, a BS may be understood as a comprehensive term including a remote radio head (RRH), an eNB, a gNB, a TP, a reception point (RP), a relay, and the like.

In the description of the embodiment, the expression ‘greater than/above A’ may be replaced with the expression ‘above/greater than A’.

In the description of the embodiment, the expression ‘less than/below B’ may be replaced with the expression ‘below/less than B’.

A method according to one embodiment described below may be applied to all periodic/semi persistent/aperiodic SRSp transmissions.

The method according to an embodiment described below may be applied to transmission power configuration for transmission in an inactive state of normal SRS as well as SRSp.

In Rel-17, it is determined that positioning measurement in an RRC inactive state is supported. Relevant Positioning Reference Signal (PRS) and SRS resources may be configured in and/or out of an initial BWP for the gain in terms of accuracy. SRS for positioning may perform transmission power determination for SRSp (SRS for positioning) through open loop power control without a separate TPC command of a base station.

However, when the SRSp is simply transmitted based on the open loop power control, a base station may be unable to receive SRS and/or miss detection may occur on the base station side. That is, since a UE has mobility, it may be inappropriate to intactly apply an Information Element (IE) configured in an RRC connected state to the UE in an RRC inactive state.

According to one embodiment, a power configuration method for a separate SRSp for an inactive state may be provided to prevent such a problem.

According to one embodiment, in an RRC inactive state, transmission power of SRSp P may be determined based on power of a signal transmitted by a UE before SRSp transmission. For example, correction/compensation for an IE configured for a UE in an RRC connected state may be performed based on power of a signal transmitted by the UE before SRSp transmission.

FIG. 7 is a simplified diagram illustrating an operating method of a UE, a TRP, a location server, and/or an LMF according to the embodiment.

Referring to FIG. 7, in operation 1301 according to the embodiment, the location server and/or the LMF may transmit configuration indicated to the UE and the UE may receive the configuration information.

In operation 1303 according to the embodiment, the location server and/or the LMF may transmit reference configuration information to the TRP and the TRP may receive the reference configuration information. In operation 1305 according to the embodiment, the TRP may transmit the reference configuration information to the UE and the UE may receive the reference configuration information. In this case, operation 1301 according to the embodiment may be omitted.

In contrast, operations 1303 and 1305 according to the embodiment may be omitted. In this case, operation 1301 according to the embodiment may be performed.

That is, operation 1301 according to the embodiment, and operations 1203 and 1205 according to the embodiment may be selectively performed.

In operation 1307 according to the embodiment, the TRP may transmit a signal related to the configuration information and the UE may receive the signal related to the configuration information. For example, the signal related to the configuration information may be a signal for positioning of the UE.

In operation 1309 according to the embodiment, the UE may transmit a signal related to positioning to the TRP and the TRP may receive the signal related to positioning. In operation 1311 according to the embodiment, the TRP may transmit the signal related to positioning to the location server and/or the LMF and the location server and/or the LMF may receive the signal related to positioning.

In operation 1313 according to the embodiment, the UE may transmit the signal related to positioning to the location server and/or the LMF and the location server and/or the LMF may receive the signal related to positioning. In this case, operations 1309 and 1311 according to the embodiment may be omitted.

In contrast, operation 1313 according to the embodiment may be omitted. In this case, operations 1309 and 1311 according to the embodiment may be performed.

That is, operations 1309 and 1311 according to the embodiment, and operation 1213 according to the embodiment may be selectively performed.

According to the embodiment, the signal related to positioning may be obtained based on the configuration information and/or the signal related to the configuration information.

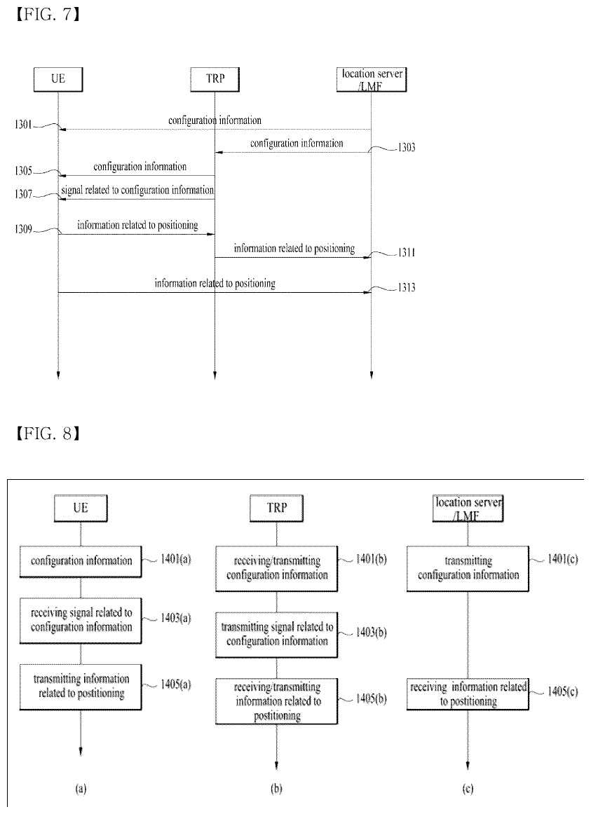

FIG. 8 is a simplified diagram illustrating an operating method of a UE, a TRP, a location server, and/or an LMF according to the embodiment.

Referring to FIG. 8(a), in operation 1401(a) according to the embodiment, the UE may receive configuration information.

In operation 1403(a) according to the embodiment, the UE may receive a signal related to the configuration information.

In operation 1405(a) according to the embodiment, the UE may transmit information related to positioning.

Referring to FIG. 8(b), in operation 1401(b) according to the embodiment, the TRP may receive configuration information from the location server and/or the LMF and transmit the configuration information to the UE.

In operation 1403(b) according to the embodiment, the TRP may transmit a signal related to the configuration information.

In operation 1405(b) according to the embodiment, the TRP may receive information related to positioning and transmit the information related to positioning to the location server and/or the LMF.

Referring to FIG. 8(c), in operation 1401(c) according to the embodiment, the location server and/or the LMF may transmit configuration information.

In operation 1405(c) according to the embodiment, the location server and/or the LMF may receive information related to positioning.

For example, the above-described configuration information may be understood as relating to reference configuration (information) or one or more pieces of information that the location server, the LMF, and/or the TRP transmits to/configures for the UE and/or may be understood as the reference configuration (information) or one or more pieces of information that the location server, the LMF, and/or the TRP transmits to/configures for the UE, in a description of the embodiment below.

For example, the above signal related to positioning may be understood as a signal related to one or more pieces of information that the UE reports and/or a signal including one or more pieces of information that the UE reports, in a description of the embodiment below.

For example, in a description of the embodiment below, the BS, the gNB, and the cell may be replaced with the TRP, the TP, or any device serving equally as the TRP or the TP.

For example, in a description of the embodiment below, the location server may be replaced with the LMF and any device serving equally as the LMF.

More detailed operations, functions, terms, etc. in operation methods according to the embodiment may be performed and described based on the embodiment described later. The operation methods according to the embodiment is exemplary and one or more operations in the above-described operation methods may be omitted according to detailed content of each embodiment.

Hereinafter, the embodiment will be described in detail. It may be understood by those of ordinary skill in the art that the embodiment described below may be combined in whole or in part to implement other embodiments unless mutually exclusive.

Since Rel-17, positioning measurement may be supported not only in a RRC connected state but also in an inactive state. Information on an SRS resources to be transmitted in DL+UL positioning measurement such as UL and/or multi-RRT at a UE side is suspended for resources delivered already in a connected state through a message for releasing RRC connection by a base station, the UE side may perform SRS transmission in the inactive state based on the corresponding configuration. And/or, the UE may receive resource configuration information on a separate SRS RSU in the inactive state through DL Small Data Transmission (SDT) and/or other DL channel.

Power configuration for SRSp for a connected/inactive state may refer to Table 3.

TABLE 3
In 38.213 v17.1,0
If a UE transmits SRS based on a configuration by SRS-PosResourceSet on active
UL BWP b of carrier f of serving cell c, the UE determines the SRS
transmission power P_{SRS,b,f,c}(i, qₛ) in SRS transmission occasion i as
$P \text{?} ( i , {q}_{i} ) = min \{ \begin{matrix}P \text{?} ( i ) , \\ P \text{?} ( q \text{?} ) + 10 {log}_{10} ( 2 \text{?} \cdot M \text{?} + α \text{?} ( {q}_{c} ) + PL \text{?}\end{matrix} \} [ dBm ]$
where,
P_{O}_SRS,b,f,c(qₛ) and α_{SRS,b,f,c}(qₛ) are provided by p0-r16 and alpha-r16
respectively, for active UL BWP b of carrier f of serving cell c, and SRS
resource set qₛ is indicated by SRS-PosResourceSetId from SRS-PosResourceSet,
and
PL_{b,f,c}(q_{d}) is a downlink pathloss estimate in dB calculated by the UE, as
described in clause 7.1.1 in case of an active DL BWP of a serving cell c, using
RS resource indexed q_{d} in a serving or non-serving cell for SRS resource set qₛ
[6, TS 38.214]. A configuration for RS resource index. q_{d} associated with SRS
resource set qₛ is provided by pathlossReferenceRS-Pos
if a ssb-IndexNcell is provided, referenceSignalPower is provided by
ss-PBCH-BlockPower-r16
if a dl-PRS-Resourceld is provided, referenceSignalPower is provided by
dl-PRS-ResourcePower
If the UE is in the RRC_CONNECTED state and determines that the UE is not
able to accurately measure PL_{b,f,c}(q_{d}), or the UE is not provided with
pathlossReferenceRS-Pos, the UE calculates PL_{b,f,c}(q_{d}) using a RS resource
obtained from the SS/PBCH block of the serving cell that the UE uses to obtain
MIB. If the UE is in the RRC_INACTIVE state and determines that the UE is not
able to accurately measure PL_{b,f,c}(q_{d}), the UE does not transmit SRS for the SRS
resource set.
The UE may indicate a capability for a number of pathloss estimates that the UE
can simultaneously maintain for all SRS resource sets provided by
SRS-PosResourceSet in addition to the up to four pathloss estimates that the UE
maintains per serving cell for PUSCH/PUCCH transmissions and for SRS
transmissions configured by SRS-Resource.
$\text{?} \text{indicates text missing or illegible when filed}$

Referring to Table 3, the base station may transmit values of p0 and alpha value for each target SRS resource set through RRC with respect to P_{o_SRSb,f,c}(qₛ) and a_{SRSb,f,c}(qₛ) required for transmission power P_{SRSb,f,c}(t, q_{z}) for SRSp occasion when configuring SRSp resources. P0 and alpha are IEs supported optically, and it may also be expected that the base station does not transmit the corresponding values.

However, in the case of an inactive state in which a location and channel state of a UE are not accurately known, it may be difficult for the base station to transmit an accurate p0 and/or alpha value to the corresponding UE. And/or, the p0 and/or alpha value transmitted in the RRC connected may be difficult to be applied to the UE in an RRC inactive state.

According to one embodiment, a power configuring method for SRSp, which may be used to prepare for a case in which an accurate p0 and/or alpha value is not transmitted by a base station, may be provided.

According to one embodiment, transmission power for SRSp may be determined/configured using power of another UL signal transmitted by a UE before SRSp transmission. According to one embodiment, when transmission is performed simply using transmission power according to path loss and/or BW size used for SRS transmission, performance degradation caused due to a herability problem may be prevented.

A transmission power configuring method according to one embodiment may be different for each scenario as follows. According to one embodiment, a type of a UL signal is different for each scenario, and an SRSp transmission power determining method may be different depending on the type of the UL signal. Unless otherwise stated, the UL signal used for determining the SRSp transmission power may include a most recently transmitted UL signal immediately before SRSp transmission.

### Case #1: Case of Transmitting PRACH (Preamble) by a UE Before SRSp Transmission

According to one embodiment, a UE may perform power ramping in transmitting and/or retransmitting PRACH (e.g., msg 1, msg A). According to an embodiment, when the UE transmits the PRACH before a configured SRSp resource, the UE may additionally utilize a ramp-up power used for the corresponding preamble in SRSp transmission power configuration.

According to an embodiment, power as much as a total power ramp-up (ΔP_{rampup_requested,b,f,c}) used in transmission for PRACH may be added intactly and transmitted.

According to an embodiment, ΔP_{rampup_requested,b,f,c} may be provided by higher layers and corresponds to the total power ramp-up requested by higher layers from the first to the last preamble for active UL BWP b of carrier f of serving cell c.

According to an embodiment, the UE may configure P_{SRSb,f,c}(t, q_{z})+ΔP_{rampup_requested,b,f,c} amounting to P_{SRSb,f,c}(t, q_{z}) and ΔP_{rampup_requested,b,f,c} which is a ramp-up size) used in recent transmission of PRACH as transmission power for SRSp transmission. According to an embodiment, the UE may determine/configure the transmission power for the SRSp transmission by compensating for ΔP_{rampup_requested,b,f,c} With respect to P_{SRSb,f,c}(t, q_{z}).

And/or, according to an embodiment, instead of fully using the corresponding value (ΔP_{rampup_requested,b,f,c}),, the base station may separately instruct and configure a power offset value that can be added and/or attenuated in units of dbm for the corresponding value, and/or may adjust an application magnification of the corresponding ramp power in a manner of introducing a separate parameter (weight element) that may have a value from 0 to 1 and then being multiplied by the corresponding value.

And/or, according to an embodiment, the base station may indicate/configure transmission power of a maximum upper limit for the application of the corresponding ramp-up. According to an embodiment, it is possible to prevent a large interference from being caused to a neighbor TRP due to the indiscriminate transmission power configuration for SRSp.

According to an embodiment, the above-described additional variable/parameter in the base station may be transmitted through RRC and/or system information, and one or more variables may be combined and used for SRSp transmission.

Case #2: Case of Receiving. By a UE. TPC Information from a Random Access Response (RAR) Before SRSp Transmission

According to an embodiment, if a base station receives a separate TPC (e.g., δ_{msg2,b,f,c}) for PUSCH transmission such as transmission of msg 3 and/or msg B before SRSp transmission, it becomes a case that a UE side may additionally apply it to SRSp by utilizing the corresponding command. In this case, the definition of δ_{msg2,b,f,c} may refer to Table 4.

TABLE 4
δ [symbol] is the TPC command value indicated in the random access response
grant corresponding to the random access preamble that the UE
transmitted on active UL BWP b of carrier f of the serving cell c [symbol] and
ΔP [symbol] = min[max(0,P [symbol] − (P [symbol] + 10log₁₀ ( [symbol]
M [symbol]
where Δ [symbol] is provided by higher layers and corresponds to
the total power ramp-up requested by higher layers from the first to the
last preamble for active UL BWP b of carrier f of serving cell c. [symbol]
indicates data missing or illegible when filed

According to an embodiment, a UE may determine transmission power of SRSp by additionally compensating by δd_{msg2,b,f,c} in addition to P_{SRS,b,f,c} (i,qₛ).

And/or, according to an embodiment, transmission power may be configured for SRSp transmission by adding additional power received through a grant to the power calculated in Case #1. According to an embodiment, the UE may transmit SRSp by adding δ_{msg2,b,f,c} to the transmission power value obtained through Case #1.

And/or, according to an embodiment, a base station may configure to correct δ_{msg2,b,f,c} by utilizing an offset value or application ratio (e.g., ‘a separate parameter that may have a value from 0 to 1 in Case #1) with respect to δ_{msg2,b,f,c}, as described in case #1. According to an embodiment, the base station may separately indicate/configure a power limitation value for total transmission power as described in Case #1.

Case #3: Case of Transmitting, by a UE, a UL Channel (e.g., PUSCH or PUCCH) Other than PRACH/Msg3 Before SRSp Transmission

According to an embodiment, a UE may configure transmission power for final SRSp by considering and utilizing the following additional power variables of PUSCH and/or PUCCH transmitted before an SRSp.
PUSCH: Δ_{TF,b,f,c} (i−1)+f_{b,f,c} (i−1,l−1) (i: PUSCH transmission occasion)
PUCCH: Δ_{F_PUCCH} (F)+Δ_{TF,b,f,c} (i−1)+g_{b,f,c} (i−1, l−1) (i: PUCCH transmission occasion)

According to an embodiment, the definition of each variable may refer to Tables 5 (PUSCH) and Table 6 (PUCCH). According to an embodiment, the definition of each variable may refer to the above-described uplink power control.

TABLE 6
The parameter Δ_{F}_PUCCH(F) is a value of deltaf-PUCCH-f0 for PUCCH format 0,
deltaF-PUCCH-f1 for PUCCH format 1, deltaF-PUCCH-f2 for PUCCH format 2,
deltaf-PUCCH-f3 for PUCCH format, 3, and deltaf-PUCCH-f4 for PUCCH format 4, if
provided; otherwise Δ_{F}_PUCCH(F) = 0.
Δ_{TF,b,f,c}(i) is a PUCCH transmission power adjustment component on active UL BWP
b of carrier f of primary cell c
For a PUCCH transmission using PUCCH format 0 or PUCCH format 1, Δ_{TF,b,f,c}(i) =
$10 {log}_{10} ( \frac{{N}_{ref}^{PUCCH}}{{N}_{symb}^{PUCCH} ( i )} ) + {Δ}_{UCI} ( i ) where$
N_{symb}^{PUCCH}(i) is a number of PUCCH format 0 symbols or PUCCH format 1 symbols for the
PUCCH transmission as described in clause 9.2.
N_{ref}^{PUCCH} = 2 for PUCCH format 0
N_{ref}^{PUCCH} = N_{symb}^{slot} for PUCCH format 1
Δ_{UCI}(i) = 0 for PUCCH format 0
Δ_{UCI}(i) = 10log₁₀(O_{UCI}(i)) for PUCCH format 1, where O_{UCI}(i) is a number of UCI bits in
PUCCH transmission occasion i
For a PUCCH transmission using PUCCH format 2 or PUCCH format 3 or PUCCH format 4
and for a number of UCI bits smaller than or equal to 11, Δ_{TF,b,f,c}(i) = 10log₁₀(K₁ ·
(n_{HARQ-ACK}(i) + O_{SR}(i) + O_{CSI}(i)/N_{RE}(i), where
K₁ = 6
n_{HARQ-ACK}(i) is a number of HARQ-ACK information bits that the UE determines as described
in clause 9.1.2.1 or 16.5.1.1 for Type-1 HARQ-ACK codebook and as described in clause 9.1.3.1
or 9.1.3.3 or 16.5.2.1 for Type-2 HARQ-ACK codebook. n_{HARQ-ACK}(i) is the same as
O_{ACK}(i) as described in clause 9.1.4 for Type-3 HARQ-ACK codebook. If the UE is not
provided any of pdsch-HARQ-ACK-Codebook, pdsch-HARQ-ACK-Codebook-r16, or
pdsch-HARQ-ACK-OneShotFeedback, n_{HARQ-ACK}(i) = 1 if the UE includes a HARQ-ACK
information bit in the PUCCH transmission; otherwise, n_{HARQ-ACK}(i) = 0
O_{SR}(i) is a number of SR information bits that the UE determines as described in clause 9.2.5.1
O_{CSI}(i) is a number of CSI information bits that the UE determines as described in clause
9.2.5.2
N_{RE}(i) is a number of resource elements determined as N_{RE}(i) = M_{RB,b,f,c}^{PUCCH}(i) · N_{sc,ctrl}^{RB}(i) ·
N_{symb-UCI,b,f,c}^{PUCCH}(i), where N_{sc,ctrl}^{RB}(i) is a number of subcarriers per resource block excluding
subcarriers used for DM-RS transmission, and · N_{symb-UCI,b,f,c}^{PUCCH}(i) is a number of symbols
excluding symbols used for DM-RS transmission, as defined in clause 9.2.5.2, for PUCCH
transmission occasion i on active UL BWP b of carrier f of primary cell c
For a PUCCH transmission using PUCCH format 2 or PUCCH format 3 or PUCCH format 4
and for a number of UCI bits larger than 11, Δ_{TF,b,f,c}(i) = 10log₁₀(2^{BPRE·K}^{₂} − 1), where
K₂ = 2.4
BPRE(i) = (O_{ACK}(i) + O_{SR}(i) + O_{CSI}(0) + O_{CRC}(i)/N_{RE}(i)
O_{ACK}(i) is a number of HARQ-ACK information bits that the UE determines as described in
clause 9.1.2.1 or 16.5.1.1 for Type-1 HARQ-ACK codebook and as described in clause 9.1.3.1
or 9.1.3.3 or 16.5.2.1 for Type-2 HARQ-ACK codebook, or as described in clause 9.1.4 for
Type-3 HARQ-ACK codebook. If the UE is not provided any of pasch-HARQ-ACK-Codebook,
pdsch-HARQ-ACK-Codehook-r16, or pasch-HARQ-ACK-OneShotFeedback, O_{ACK} = 1 if the
UE includes a HARQ-ACK information bit in the PUCCH transmission; otherwise, O_{ACK} = 0
O_{SR}(i) is a number of SR information bits that the UE determines as described in clause 9.2.5.1
O_{CSI}(i) is a number of CSI information bits that the UE determines as described in clause
9.2.5.2
O_{CRC}(i) is a number of CRC bits that the UE determines as described in clause 9.2
N_{RE}(i) is a number of resource elements that the UE determines as N_{RE}(i) = M_{RB,b,f,c}^{PUCCH}(i).
N_{sc,ctrl}^{RB}(i) · N_{symb-UCI,b,f,c}^{PUCCH}(i), where N_{sc,ctrl}^{RB}(i) is a number of subcarriers per resource block
excluding subcarriers used for DM-RS transmission, and N_{symb-UCI,b,f,c}^{PUCCH}(i) is a number of
symbols excluding symbols used for DM-RS transmission, as defined in clause 9.2.5.2, for
PUCCH transmission occasion i on active UL BWP b of carrier f of primary cell c.
For the PUCCH power control adjustment state g_{b,f,c}(i, l) for active UL BWP b of
carrier f of primary cell c and PUCCH transmission occasion i
δ_{PUCCH,b,f,c}(i, l) is a TPC command value included in a DCI format associated with the PUCCH
transmission for active UL BWP b of carrier f of the primary cell c that the UE detects for
PUCCH transmission occasion i, or is jointly coded with other TPC commands in a DCI format
2_2 with CRC scrambled by TPC-PUCCH-RNTI [5, TS 38.212], as described in clause 11.3
l ∈ {0, 1} if the UE is provided twoPUCCH-PC-AdjustmentStates and
PUCCH-SpatialRelationInfo, or more than one sets of power control parameters for operation in
FR1, and l = 0 if the UE is not provided twoPUCCH-PC-AdjustmentStates or
PUCCH-SpatialRelationinfo, and more than one sets of power control parameters
If the UE obtains a TPC command value from a DCI format associated with the PUCCH
transmission and if the UE is provided PUCCH-SpatialRelationInfo, the UE obtains a mapping.
by an index provided by p0-PUCCH-Id, between a set of pucch-SpatialRelationInfold values and
a set of values for closedLoopIndex that provide the l value(s). If the UE receives an activation
command indicating a value of pucch-SpatialRelationInfold, the UE determines the value
closedLoopIndex that provides the value of l through the link to a corresponding p0-PUCCH-Id
index
If the UE obtains a TPC command from a DCI format 2_2 with CRC scrambled by a
TPC-PUCCH-RNTI, the l value is provided by the closed loop indicator field in DCI format
2_2
If the UE transmits the PUCCH with N_{PUCCH}^{repeat} > 1 repetitions, as described in clause 9.2.6, and
the UE is provided twoPUCCH-PC-AdjustmentStates by pucch-PowerControl
If the DCI format includes two TPC command values and the PUCCH resource of the PUCCH
transmission is associated with l = 0 and l = 1. the UE applies the first TPC command value
for l = 0 and applies the second TPC command value for l = 1
If the DCI format includes two TPC command values and the PUCCH resource of the PUCCH
transmission is associated with l = 0, the UE applies the first TPC command value for l = 0
and ignores the second TPC command value
If the DCI format includes two TPC command values and the PUCCH resource of the PUCCH
transmission is associated with l = 1, the UE applies the second TPC command value for l = 1
and ignores the first TPC command value
If the DCI format includes one TPC command value, the UE applies the TPC command value for
all l associated with the PUCCH resource of the PUCCH transmission
g_{b,f,c}(i, l) = g_{b,f,c}(i − i₀, l) + Σ [symbol] δ_{PUCCH,b,f,c}(m, l) is the current PUCCH power control
adjustment state l for active UL BWP b of carrier f of primary cell c and PUCCH
transmission occasion i, where
The δ_{PUCCH,b,f,c} values are given in Table 7.1.2-1
Σ [symbol] δ_{PUCCH,b,f,c}(m, l) is a sum of TPC command values in a set Cᵢ of TPC command
values with cardinality [symbol] (Cᵢ) that the UE receives between K_{PUCCH}(i − i₀) − 1 symbols before
PUCCH transmission occasion i - i₀ and K_{PUCCH}(i) symbols before PUCCH transmission
occasion i on active UL BWP b of carrier f of primary cell c for PUCCH power control
adjustment state, where i₀ > 0 is the smallest integer for which K_{PUCCH}(i − i₀) symbols
before PUCCH transmission occasion i − i₀ is earlier than K_{PUCCH}(i) symbols before PUCCH
transmission occasion i
If the PUCCH transmission is in response to a detection by the UE of a DCI format, K_{PUCCH}(i)
is a number of symbols for active UL BWP b of carrier f of primary cell c after a last
symbol of a corresponding PDCCH reception and before a first symbol of the PUCCH
transmission
If the PUCCH transmission is not in response to a detection by the UE of a DCI format,
K_{PUCCH}(i) is a number of K_{PUCCH,min} symbols equal to the product of a number of symbols per
slot, N_{symb}^{slot}, and the minimum of the values provided by k2 in PUSCH-ConfigCommon for
active UL BWP b of carrier f of primary cell c
If the UE has reached maximum power for active UL BWP b of carrier f of primary cell c at
PUCCH transmission occasion i − i₀ and Σ [symbol] δ_{PUCCH,b,f,c}(m, l) ≥ 0, then g_{b,f,c}(i, l) =
g_{b,f,c}(i − i₀, l)
If UE has reached minimum power for active UL BWP b of carrier f of primary cell c at
PUCCH transmission occasion i − i₀ and Σ [symbol] δ_{PUCCH,b,f,c}(m, l) ≤ 0, then g_{b,f,c}(i, l) =
g_{b,f,c}(i − i₀, l)
If a configuration of a P_{O}_PUCCH,b,f,c(qᵤ) value for a corresponding PUCCH power control
adjustment state l for active UL BWP b of carrier f of primary cell c is provided by higher
layers.
g_{b,f,c}(k, 1) = 0, k = 0, 1, ... , i
if the UE is provided PUCCH-SpatialRelationInfo, the UE determines the value of l from the
value of qᵤ based on a pucch-SportalRelationInfold value associated with the p0-PUCCH-Id
value corresponding to qᵤ and with the closedLoopIndex value corresponding to l;
else, if the UE is provided more than one sets of power control parameters for operation in FR1,
and if the UE receives an activation command for a PUCCH resource that indicates one or two
sets of the more than one sets of power control parameters, the UE determines the value of l
based on the closedLoopIndex value in the one or two sets of power control parameters;
else, l = 0
Else,
g_{b,f,c}(0, l) = ΔP_{rampup,b,f,c} + δ_{b,f,c}, where l = 0, and δ_{b,f,c} is
the TPC command value indicated in a random access response grant corresponding to a
PRACH transmission according to Type-1 random access procedure, or in a random access
response grani corresponding to MsgA transmissions according to Type-2 random access
procedure with RAR message(s) for fallbackRAR, or
the TPC command value indicated in a successRAR corresponding to MagA transmissions for
Type-2 random access procedure, or
the TPC command value in a DCI format with CRC scrambled by C-RNTI or MCS-C-RNTI that
the UE derects in a first PDCCH reception in a search space set provided by
recoverySearchSpaceId if the PUCCH transmission is a first PUCCH transmission after 28
symbols from a last symbol of the first PDCCH reception.
and, if the UE transmits PUCCH on active UL BWP b of carrier f of primary cell c,
ΔP_{rampup,b,f,c} = min[max (0, P_{CMAX,f,c} − (P_{O}_PUCCH,b,f,c + PL_{b,f,c}(q_{d}) + Δ_{F}_PUCCH +
Δ_{TF,b,f,c} + δ_{b,f,c})), ΔPᵣₐₘₚᵤₚ_requested,b,f,c];
otberwise,
ΔP_{rampup,b,f,c} =
min[max 0, P_{CMAX,f,c} − (P_{O}_PUCCH,b,f,c + PL_{b,f,c}(q_{d}))), ΔPᵣₐₘₚᵤₚ_requested,b,f,c] where
ΔPᵣₐₘₚᵤₚ_requested,b,f,c is provided by higher layers and corresponds to the total power ramp-up
requested by higher layers from the first to the last preamble for active UL BWP b of carrier f
of primary cell c, and Δ_{F}_PUCCH corresponds to PUCCH format 0 or PUCCH format 1 [symbol]
indicates data missing or illegible when filed

According to an embodiment, the value may be additionally applied as it is according to a previous channel of the UE. According to an embodiment, when PUSCH is transmitted before SRSp, the UE configures transmission power of SRSp by P_{SRS,b,f,c} (i, qₛ)+Δ_{TF,b,f,c}+f_{b,f,c} (i−1, l−1). When PUCCH is transmitted before SRSp, the UE may configure transmission power of SRSp by P_{SRS,b,f,c} (i, qₛ)+Δ_{TF,b,f,c} (i−1)+g_{b,f,c} (i−1, l−1).

And/or, according to an embodiment, a base station may transmit a single offset value in dBM value for total additional power for each channel to the UE and/or transmit a magnification for each parameter (e.g., ‘a separate parameter that may have a value from 0 to 1′ in Case #1), so that the base station may directly instruct a detailed configuration for each value. According to an embodiment, as described in Case #1, the base station may separately indicate/configure a power limitation value for the total transmission power.

For example, due to the nature of an active state, since data transmission to the UE from the base station through the RRC is limited, information transmitted by movement of the UE may not be valid. For example, the additional power variable used for PRACH/msg3/PUSCH/PUCCH before the SRSp descried above may no longer be valid.

To this end, according to an embodiment, the base station may transmit a window for a time for ensuring that the configuration is valid through separate system information and/or RRC. According to an embodiment, only when other UL channel is transmitted within a window based on a start symbol and/or slot of the SRSp, the UE may expect to transmit the SRSp by configuring transmission power for the SRSp through the method according to the embodiment described above.

According to an embodiment, when other UL channel is not transmitted in the window, the UE may transmit SRSp using power of P_{SRS,b,f,c} (i, qₛ). That is, according to an embodiment, compensation may not be performed in this case. It is transmitted.

According to an embodiment, a configuration unit of the window may include a symbol, slot, subframe, or frame unit.

According to an embodiment, even if the base station provides p0 and alpha values through RRC, the UE may combine and apply at least some of the discussed variables other than the basic transmission power (P_{SRS,b,f,c} (i, qₛ) variable in the method according to the embodiment described above. According to an embodiment, when an obtained value exceeds maximum transmission power of the UE, the UE may expect to transmit SRSp using only the maximum transmission power.

According to an embodiment, the cases according to the embodiment described above may be applied in combination with each other. According to an embodiment, a detailed method for each case may also be combined and used. According to an embodiment, irrespective of the case, the additional variable at the base station proposed in the corresponding detailed method may be transmitted from the base station to the UE through RRC or system information, and at least a part thereof may be combined and used for SRSp transmission.

According to an embodiment, a correction parameter (offset value) additionally configured for the above-described case-specific basic parameter (e.g., msg2,b,f,c in Case #2) is combined irrespective of case, and when the basic parameter is used, a correction parameter value for each basic parameter may be transmitted as a single value or may be separately indicated/configured for each correction parameter.

FIG. 9 is a diagram schematically illustrating an operation method of a UE and a network node according to the embodiment.

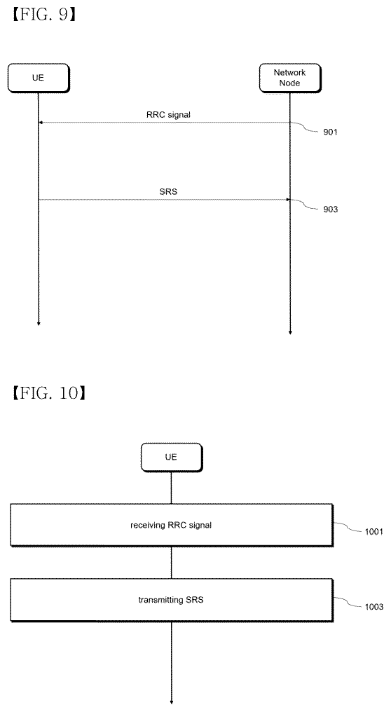

FIG. 10 is a flowchart illustrating an operating method of a UE according to the embodiment.

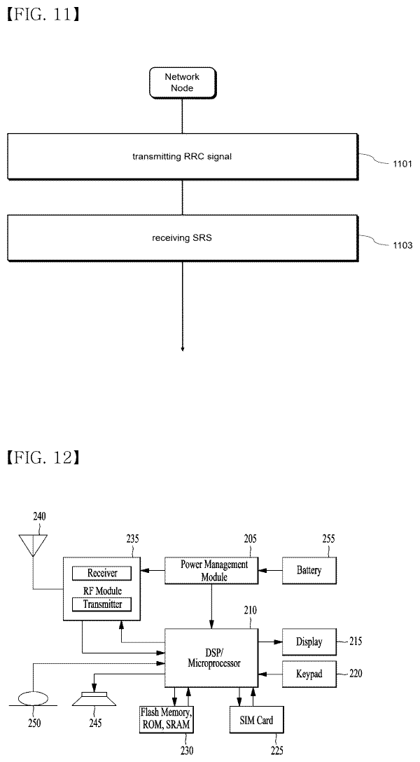

FIG. 11 is a flowchart illustrating an operating method of a network node according to the embodiment. For example, the network node may be a TP, a BS, a cell, a location server, an LMF, and/or any device that performs the same operation.

Referring to FIGS. 9 to 11, in operations 901, 1001, and 1101 according to an embodiment, a network node may transmit a Radio Resource Control (RRC) signal including configuration information of a Sounding Reference Signal (SRS), and a UE may receive it.

According to an embodiment, the configuration information may include one or more parameters for determining transmission power of the SRS.

In operations 903, 1003, and 1103 according to an embodiment, the UE may transmit SRS based on the configuration information, and the network node may receive it.

According to an embodiment, the RRC signal may be transmitted/received in an RRC connected state.

According to an embodiment, based on that: (i) SRS is transmitted and received in an RRC inactive state; and (ii) an Uplink (UL) signal different from the SRS is transmitted by the UE in the RRC active state before to SRS transmission, transmission power may be determined based on one or more parameters and one or more power offsets for compensation of the one or more parameters.

According to this configuration, the one or more power offsets may be determined based on the UL signal.

Specific operations of the UE and/or the network node according to the above-described the embodiment may be described and performed based on Section 1 to Section 3 described before.

Since examples of the above-described proposal method may also be included in one of implementation methods of the embodiment, it is obvious that the examples are regarded as a sort of proposed methods. Although the above-proposed methods may be independently implemented, the proposed methods may be implemented in a combined (aggregated) form of a part of the proposed methods. A rule may be defined such that the BS informs the UE of information as to whether the proposed methods are applied (or information about rules of the proposed methods) through a predefined signal (e.g., a physical layer signal or a higher-layer signal).

### 4. Exemplary Configurations of Devices Implementing The Embodiment

### 4.1. Exemplary configurations of devices to which the embodiment is applied

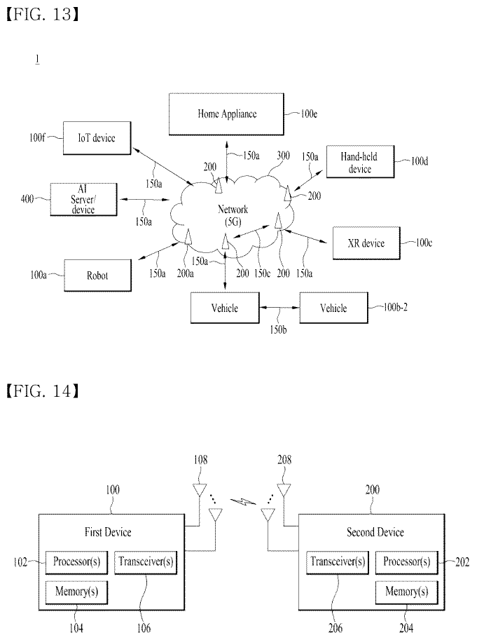

FIG. 12 is a diagram illustrating a device that implements the embodiment.

The device illustrated in FIG. 12 may be a UE and/or a BS (e.g., eNB or gNB or TP) and/or a location server (or LMF) which is adapted to perform the above-described mechanism, or any device performing the same operation.

Referring to FIG. 12, the device may include a digital signal processor (DSP)/microprocessor 210 and a radio frequency (RF) module (transceiver) 235. The DSP/microprocessor 210 is electrically coupled to the transceiver 235 and controls the transceiver 235. The device may further include a power management module 205, a battery 255, a display 215, a keypad 220, a SIM card 225, a memory device 230, an antenna 240, a speaker 245, and an input device 250, depending on a designer's selection.

Particularly, FIG. 12 may illustrate a UE including a receiver 235 configured to receive a request message from a network and a transmitter 235 configured to transmit timing transmission/reception timing information to the network. These receiver and transmitter may form the transceiver 235. The UE may further include a processor 210 coupled to the transceiver 235.

Further, FIG. 12 may illustrate a network device including a transmitter 235 configured to transmit a request message to a UE and a receiver 235 configured to receive timing transmission/reception timing information from the UE. These transmitter and receiver may form the transceiver 235. The network may further include the processor 210 coupled to the transceiver 235. The processor 210 may calculate latency based on the transmission/reception timing information.

A processor of a UE (or a communication device included in the UE) and/or a BS (or a communication device included in the BS) and/or a location server (or a communication device included in the location server) may operate by controlling a memory, as follows.

According to the embodiment, the UE or the BS or the location server may include at least one transceiver, at least one memory, and at least one processor coupled to the at least one transceiver and the at least one memory. The at least one memory may store instructions which cause the at least one processor to perform the following operations.

The communication device included in the UE or the BS or the location server may be configured to include the at least one processor and the at least one memory. The communication device may be configured to include the at least one transceiver or to be coupled to the at least one transceiver without including the at least one transceiver.

The TP and/or the BS and/or the cell and/or the location server and/or the LMF and/or any device performing the same operation may be referred to as a network node.

According to an embodiment, one or more processors included in a UE (or one or more processors of a communication device included in the UE) may be configured to receive a Radio Resource Control (RRC) signal containing configuration information of a Sounding Reference Signal (SRS).

According to an embodiment, the configuration information may include one or more parameters for determining the transmission power of the SRS.

According to this configuration, the one or more processors included in the UE may be configured to transmit the SRS based on the configuration information.

According to an embodiment, the RRC signal may be received in an RRC connected state.

According to an embodiment, based on that: (i) the SRS is transmitted in an RRC inactive state; and (ii) an Uplink (UL) signal different from the SRS is transmitted by the UE in the RRC inactive state before transmission of the SRS, the transmission power may be determined based on the one or more parameters and one or more power offsets for compensation of the one or more parameters.

According to an embodiment, the one or more power offsets may be determined based on the UL signal.

According to an embodiment, one or more processors included in a network node (or one or more processors of a communication device included in the network node) may be configured to transmit a Radio Resource Control (RRC) signal containing configuration information of a Sounding Reference Signal (SRS).

According to an embodiment, the configuration information may include one or more parameters for determining transmission power of the SRS.

According to an embodiment, the one or more processors are configured to receive the SRS related to the configuration information from the UE.

According to an embodiment, the RRC signal may be transmitted in an RRC connected state.

According to an embodiment, based on that: (i) the SRS is received when an RRC state of the UE is an RRC inactive state; and (ii) an Uplink (UL) signal different from the SRS from the UE in the RRC inactive state before reception of the SRS, the transmission power may be determined based on the one or more parameters and one or more power offsets for compensation of the one or more parameters.

According to an embodiment, the one or more power offsets may be determined based on the UL signal.

Specific operations of the UE and/or the network node according to the above-described the embodiment may be described and performed based on Section 1 to Section 3 described before.

Unless contradicting each other, the embodiment may be implemented in combination. For example, (the processor included in) the UE and/or the network node according to the embodiment may perform operations in combination of the embodiments of the afore-described in Section 1 to Section 3, unless contradicting each other.

### 4.2. Example of Communication System to which the Embodiment is Applied

In the present specification, the embodiment have been mainly described in relation to data transmission and reception between a BS and a UE in a wireless communication system. However, the embodiment is not limited thereto. For example, the embodiment may also relate to the following technical configurations.

The various descriptions, functions, procedures, proposals, methods, and/or operational flowcharts of the embodiment described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

FIG. 13 illustrates an exemplary communication system to which the embodiment is applied.

Referring to FIG. 13, a communication system 1 applied to the embodiment includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the embodiment.

### Example of Wireless Devices to which the Embodiment is Applied

FIG. 14 illustrates exemplary wireless devices to which the embodiment is applicable.

Referring to FIG. 14, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. W1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the embodiment, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the embodiment, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

According to the embodiment, one or more memories (e.g., 104 or 204) may store instructions or programs which, when executed, cause one or more processors operably coupled to the one or more memories to perform operations according to the embodiment or implementations of the present disclosure.

According to the embodiment, a computer-readable storage medium may store one or more instructions or computer programs which, when executed by one or more processors, cause the one or more processors to perform operations according to the embodiment or implementations of the present disclosure.

According to the embodiment, a processing device or apparatus may include one or more processors and one or more computer memories connected to the one or more processors. The one or more computer memories may store instructions or programs which, when executed, cause the one or more processors operably coupled to the one or more memories to perform operations according to the embodiment or implementations of the present disclosure.

### Example of Using Wireless Devices to which the Embodiment is Applied

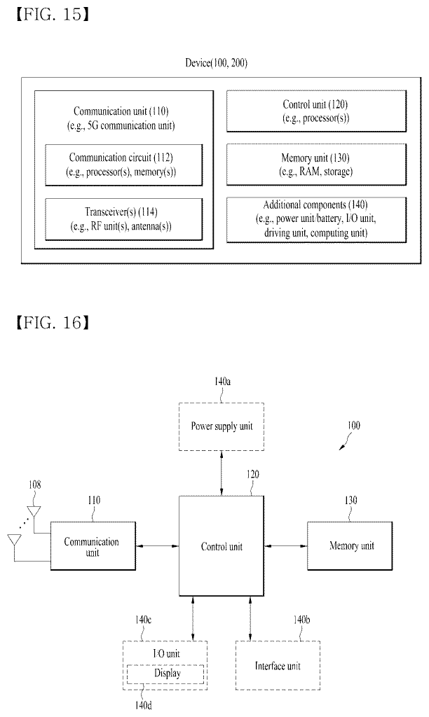

FIG. 15 illustrates other exemplary wireless devices to which the embodiment is applied. The wireless devices may be implemented in various forms according to a use case/service (see FIG. 13).

Referring to FIG. 15, wireless devices 100 and 200 may correspond to the wireless devices 100 and 200 of FIG. 14 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 14. For example, the transceiver(s) 114 may include the one or more transceivers 106 and 206 and/or the one or more antennas 108 and 208 of FIG. 14. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 13), the vehicles (100b-1 and 100b-2 of FIG. 13), the XR device (100c of FIG. 13), the hand-held device (100d of FIG. 13), the home appliance (100e of FIG. 13), the IoT device (100f of FIG. 13), a digital broadcast terminal, a hologram device, a public safety device, an MTC device, a medicine device, a fintech device (or a finance device), a security device, a climate/environment device, the AI server/device (400 of FIG. 13), the BSs (200 of FIG. 13), a network node, etc. The wireless device may be used in a mobile or fixed place according to a use-example/service.

In FIG. 15, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 15 will be described in detail with reference to the drawings.

### Example of Portable Device to which the Embodiment is Applied

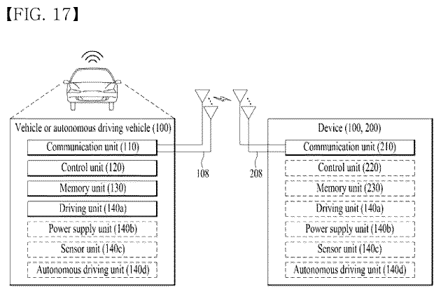

FIG. 16 illustrates an exemplary portable device to which the embodiment is applied. The portable device may be any of a smartphone, a smartpad, a wearable device (e.g., a smartwatch or smart glasses), and a portable computer (e.g., a laptop). A portable device may also be referred to as mobile station (MS), user terminal (UT), mobile subscriber station (MSS), subscriber station (SS), advanced mobile station (AMS), or wireless terminal (WT).

Referring to FIG. 16, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 15, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

### Example of Vehicle or Autonomous Driving Vehicle to which the Embodiment

FIG. 17 illustrates an exemplary vehicle or autonomous driving vehicle to which the embodiment. The vehicle or autonomous driving vehicle may be implemented as a mobile robot, a car, a train, a manned/unmanned aerial vehicle (AV), a ship, or the like.

Referring to FIG. 17, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 15, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

In summary, the embodiment may be implemented through a certain device and/or UE.

For example, the certain device may be any of a BS, a network node, a transmitting UE, a receiving UE, a wireless device, a wireless communication device, a vehicle, a vehicle equipped with an autonomous driving function, an unmanned aerial vehicle (UAV), an artificial intelligence (AI) module, a robot, an augmented reality (AR) device, a virtual reality (VR) device, and other devices.

For example, a UE may be any of a personal digital assistant (PDA), a cellular phone, a personal communication service (PCS) phone, a global system for mobile (GSM) phone, a wideband CDMA (WCDMA) phone, a mobile broadband system (MBS) phone, a smartphone, and a multi-mode multi-band (MMMB) terminal.

A smartphone refers to a terminal taking the advantages of both a mobile communication terminal and a PDA, which is achieved by integrating a data communication function being the function of a PDA, such as scheduling, fax transmission and reception, and Internet connection in a mobile communication terminal. Further, an MM-MB terminal refers to a terminal which has a built-in multi-modem chip and thus is operable in all of a portable Internet system and other mobile communication system (e.g., CDMA 2000, WCDMA, and so on).

Alternatively, the UE may be any of a laptop PC, a hand-held PC, a tablet PC, an ultrabook, a slate PC, a digital broadcasting terminal, a portable multimedia player (PMP), a navigator, and a wearable device such as a smartwatch, smart glasses, and a head mounted display (HMD). For example, a UAV may be an unmanned aerial vehicle that flies under the control of a wireless control signal. For example, an HMD may be a display device worn around the head. For example, the HMD may be used to implement AR or VR.

The wireless communication technology in which the embodiment is implemented may include LTE, NR, and 6G, as well as narrowband Internet of things (NB-IoT) for low power communication. For example, the NB-IoT technology may be an example of low power wide area network (LPWAN) technology and implemented as the standards of LTE category (CAT) NB1 and/or LTE Cat NB2. However, these specific appellations should not be construed as limiting NB-IoT. Additionally or alternatively, the wireless communication technology implemented in a wireless device according to the embodiment may enable communication based on LTE-M. For example, LTE-M may be an example of the LPWAN technology, called various names such as enhanced machine type communication (eMTC). For example, the LTE-M technology may be implemented as, but not limited to, at least one of 1) LTE CAT 0, 2) LTE Cat M1, 3) LTE Cat M2, 4) LTE non-bandwidth limited (non-BL), 5) LTE-MTC, 6) LTE machine type communication, and/or 7) LTE M. Additionally or alternatively, the wireless communication technology implemented in a wireless device according to the embodiment may include, but not limited to, at least one of ZigBee, Bluetooth, or LPWAN in consideration of low power communication. For example, ZigBee may create personal area networks (PANs) related to small/low-power digital communication in conformance to various standards such as IEEE 802.15.4, and may be referred to as various names.

The embodiment may be implemented in various means. For example, the embodiment may be implemented in hardware, firmware, software, or a combination thereof.

In a hardware configuration, the methods according to exemplary embodiments may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the embodiment may be implemented in the form of a module, a procedure, a function, etc. performing the above-described functions or operations. A software code may be stored in the memory 50 or 150 and executed by the processor 40 or 140. The memory is located at the interior or exterior of the processor and may transmit and receive data to and from the processor via various known means.

Those skilled in the art will appreciate that the embodiment may be carried out in other specific ways than those set forth herein without departing from the spirit and essential characteristics of the embodiment. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment or included as a new claim by a subsequent amendment after the application is filed

### INDUSTRIAL APPLICABILITY

The embodiment is applicable to various wireless access systems including a 3GPP system, and/or a 3GPP2 system. Besides these wireless access systems, the embodiment is applicable to all technical fields in which the wireless access systems find their applications. Moreover, the proposed method can also be applied to mmWave communication using an ultra-high frequency band.

What is claimed is:

1. A method performed by a User Equipment (UE) in a wireless communication system, the method comprising:
receiving a Radio Resource Control (RRC) signal including configuration information of a Sounding Reference Signal (SRS), the configuration information including one or more parameters for determining transmission power of the SRS; and
transmitting the SRS based on the configuration information,
wherein the RRC signal is received in an RRC connected state,
wherein based on transmitting the SRS in an RRC inactive state and (ii) transmitting an Uplink (UL) signal different from the SRS by the UE in the RRC inactive state before transmitting the SRS, the transmission power is determined based on the one or more parameters and one or more power offsets for compensation of the one or more parameters, and
wherein the one or more power offsets are determined based on the UL signal.

2. The method of claim 1,
wherein in the RRC connected state, a window is configured in a time domain,
wherein based on transmitting the SRS in the RRC inactive state, (ii) transmitting the UL signal by the UE in the RRC inactive state before transmitting the SRS, (iii) a transmission start time of the SRS being included in the window, the transmission power is determined based on the one or more parameters and the one or more power offsets, and
wherein based on transmitting the SRS in the RRC inactive state and (ii) the transmission start time of the SRS not being included in the window, the transmission power is determined based on the one or more parameters.

3. The method of claim 1,
wherein based on that a value obtained based on compensating the one or more power offsets in the one or more parameters exceeds a preset threshold, the transmission power is determined as a value related to the preset threshold and
wherein the preset threshold is a power limitation configured in the RRC connected state or a maximum transmission power of the UE.

4. The method of claim 1,
wherein a weight parameter applied to the one or more power offsets is configured,
wherein the weight parameter has a real number equal to or greater than 0 and equal to or smaller than 1, and
wherein the one or more parameters are compensated with a value obtained based on applying the weight parameter to the one or more power offsets.

5. The method of claim 1,
wherein based on the UL signal being a Physical Random Access Channel (PRACH), the one or more power offsets are determined as a total power ramp-up related to transmission of the PRACH.

6. The method of claim 1,
wherein based on the UL signal being a response signal to a Random Access Response (RAR), the one or more power offsets are determined as a Transmit Power Control (TPC) command value included in the RAR.

7. The method of claim 1,
wherein based on the UL signal being a Physical Uplink Shared Channel (PUSCH), the one or more power offsets are determined as Δ_{TP,b,f,c}(l−1)+f_{b,f,c}(i−1, l−1),
wherein Δ_{TP,b,f,c}(l−1) is a delta function used transmission power determination of the PUSCH transmitted in a PUSCH transmission occasion i−1, and
wherein f_{b,f,c}(i−1, l−1) is a value related to a PUSCH power control coordination state used for the transmission power determination of the PUSCH transmitted in the PUSCH transmission occasion i−1.

8. The method of claim 1,
wherein based on the UL BPS signal being a Physical Uplink Control Channel (PUCCH), the one or more power offsets are determined as Δ_{F_PUCCH}(F)+Δ_{TPb,f,c}(l−1)+g_{b,f,c} (i−1,l−1),
wherein Δ_{F_PUCCH}(F) is a first delta function used for transmission power determination of the PUCCH,
wherein Δ_{TPb,f,c}(l−1) is a second delta function used for the transmission power determination of the PUCCH transmitted in a PUCCH transmission occasion i−1, and
wherein g_{b,f,c} (i−1,l−1) is a value related to a PUCCH power control coordination state used for the transmission power determination of the PUCCH transmitted in the PUCCH transmission occasion i−1.

9. A User Equipment (UE) operating in a wireless communication system, the UE comprising:
a transceiver; and
one or more processors connected to the transceiver,
wherein the one or more processors are configured to receive a Radio Resource Control (RRC) signal including configuration information of a Sounding Reference Signal (SRS),
wherein the configuration information includes one or more parameters for determining transmission power of the SRS,
wherein the one or more processors are configured to transmit the SRS based on the configuration information,
wherein the RRC signal is received in an RRC connected state,
wherein based on transmitting the SRS in an RRC inactive state and (ii) transmitting an Uplink (UL) signal different from the SRS by the UE in the RRC inactive state before transmitting the SRS, the transmission power is determined based on the one or more parameters and one or more power offsets for compensation of the one or more parameters, and
wherein the one or more power offsets are determined based on the UL signal.

10. The UE of claim 9,
wherein in the RRC connected state, a window is configured in a time domain,
wherein based on transmitting the SRS in the RRC inactive state, (ii) transmitting the UL signal by the UE in the RRC inactive state before transmitting the SRS, and (iii) a transmission start time of the SRS being included in the window, the transmission power is determined based on the one or more parameters and the one or more power offsets, and
wherein based on transmitting the SRS in the RRC inactive state and (ii) the transmission start time of the SRS not being included in the window, the transmission power is determined based on the one or more parameters.

11. The UE of claim 9,
wherein the one or more processors are configured to communicate with one or more of a mobile terminal, a network, and an autonomous vehicle other than a vehicle including the UE.

12. A method performed by a base station in a wireless communication system, the method comprising:
transmitting a Radio Resource Control (RRC) signal including configuration information of a Sounding Reference Signal (SRS), the configuration information including one or more parameters for determining transmission power of the SRS; and
receiving the SRS related to the configuration information from a user equipment,
wherein the RRC signal is transmitted in an RRC connected state,
wherein based on receiving the SRS in an RRC inactive state of an RRC state of the user equipment and (ii) receiving an Uplink (UL) signal different from the SRS from the user equipment in the RRC inactive state before receiving the SRS, the transmission power is determined based on the one or more parameters and one or more power offsets for compensation of the one or more parameters, and
wherein the one or more power offsets are determined based on the UL signal.

13. A base station operating in a wireless communication system, the base station comprising:
a transceiver; and
one or more processors connected to the transceiver;
wherein the one or more processors are configured to transmit a Radio Resource Control (RRC) signal including configuration information of a Sounding Reference Signal (SRS),
wherein the configuration information includes one or more parameters for determining transmission power of the SRS,
wherein the one or more processors are configured to receive, from a user equipment, the SRS related to the configuration information,
wherein the RRC signal is transmitted in an RRC connected state,
wherein based on receiving the SRS in an RRC inactive state of an RRC state of the user equipment and (ii) receiving an Uplink (UL) signal different from the SRS from the user equipment in the RRC inactive state before receiving the SRS, the transmission power is determined based on the one or more parameters and one or more power offsets for compensation of the one or more parameters, and
wherein the one or more power offsets are determined based on the UL signal.

14. An apparatus operating in a wireless communication system, the apparatus comprising:
one or more processors; and
one or more memories operably coupled to the one or more processors and storing one or more instructions for enabling the one or more processors to perform operations based on being executed, the operations comprising:
receiving a Radio Resource Control (RRC) signal including configuration information of a Sounding Reference Signal (SRS), the configuration information including one or more parameters for determining transmission power of the SRS; and
transmitting the SRS based on the configuration information,
wherein the RRC signal is received in an RRC connected state,
wherein based on transmitting the SRS in an RRC inactive state and (ii) transmitting an Uplink (UL) signal different from the SRS by the apparatus in the RRC inactive state before transmitting the SRS, the transmission power is determined based on the one or more parameters and one or more power offsets for compensation of the one or more parameters, and
wherein the one or more power offsets are determined based on the UL signal.

15. A non-transitory processor-readable medium storing one or more instructions for enabling one or more processors to perform operations, the operations comprising:
receiving a Radio Resource Control (RRC) signal including configuration information of a Sounding Reference Signal (SRS), the configuration information including one or more parameters for determining transmission power of the SRS; and
transmitting the SRS based on the configuration information,
wherein the RRC signal is received in an RRC connected state,
wherein based on transmitting the SRS in an RRC inactive state and (ii) transmitting an Uplink (UL) signal different from the SRS by a device including the one or more processors in the RRC inactive state before transmitting the SRS, the transmission power is determined based on the one or more parameters and one or more power offsets for compensation of the one or more parameters, and
wherein the one or more power offsets are determined based on the UL signal.
